(19) United States
(12) Patent Application Publication
(10) Pub. No.: US 2020/0330924 A1
(43) Pub. Date: Oct. 22, 2020

(54) CONTROL OF THE CONCENTRATION-POLARIZATION LAYER LENGTH IN A MICROCHANNEL-MEMBRANE SYSTEM

(71) Applicant: Technion Research & Development Foundation Limited, Haifa (IL)

(72) Inventors: Gilad YOSSIFON, Haifa (IL); Sinwook PARK, Haifa (IL)

(73) Assignee: Technion Research & Development Foundation Limited, Haifa (IL)

(21) Appl. No.: 16/919,134

(22) Filed: Jul. 2, 2020

Related U.S. Application Data
(63) Continuation of application No. PCT/IL2019/050011, filed on Jan. 2, 2019.
(60) Provisional application No. 62/612,757, filed on Jan. 2, 2018.

(51) Int. Cl. B01D 61/46; B01D 69/02; B01D 69/14; B01D 71/36; C02F 1/469; B01D 61/52; B03C 5/00

(52) U.S. Cl. CPC B01D 61/46; B01D 69/02; B01D 69/144; B01D 71/36; C02F 1/4696; C02F 2103/08; B01D 61/52; B03C 5/005; B01D 2325/04; B01D 2311/2603; B01D 2313/22; C02F 1/4693

(57) ABSTRACT

A microchannel-membrane device comprises a microchannel extending through at least one electrode, the microchannel having a predetermined depth; an ionic permselective medium, such as a membrane, across the microchannel between the electrodes; and a heater, or array of heaters, embedded below the microchannel on at least one side of the permselective membrane. The heaters can be either prefabricated or dynamically patterned using laser illumination with/without photoconductive coating. The heaters are on the depletion side of the membrane and induce a vortex which limits the growth of the diffusion area. Operation of the heaters allows for controlled positioning of the end of the diffusion area and with it also the position of the preconcentrated molecule plug.

### RELATED APPLICATIONS

This application is a US Continuation of PCT Patent Application No. PCT/IL2019/050011 having international filing date of Jan. 2, 2019 which claims the benefit of priority under 35 USC § 119(e) of U.S. Provisional Patent Application No. 62/612,757 filed on Jan. 2, 2018. The contents of the above applications are all incorporated by reference as if fully set forth herein in their entirety.

### FIELD AND BACKGROUND OF THE INVENTION

The present invention, in some embodiments thereof, relates to control of polarization layer length in a microchannel-membrane system.

The limiting current of systems involving an ionic permselective interface (i.e. nanochannel, membrane) inversely depends on the length of the diffusion layer—the diffusion length. For a cation (anion) exchange membrane a depletion (enrichment) layer develops at the anodic (cathodic) side of the membrane. Hence, controlling the diffusion length is crucial for enhancing the diffusion limited current, which is related to the desalination rate in electrodialysis systems, and for the location of the preconcentrated plug of analytes and the separating line between brine and desalted streams. Currently, the length of the depletion layer is dictated indirectly by the various system parameters and involves some kind of electro-convective mechanism, e.g. electrokinetic instability, electroosmosis of the second kind, natural convection or forced flow through a convective-diffusive boundary layer. An active method for controlling the diffusion length using alternating-current-electro-osmosis (ACEO) has been previously proposed.

The mechanisms described above, can indeed suppress the growth of the depletion layer, however, there is either no control over the resulting size of the layer and/or inability to dynamically change the diffusion length. While ACEO does provide a direct way for spatio-temporal control over the diffusion length the effect is limited to solutions of low conductivity and hence a more generic method that is applicable also to concentrated solutions is needed.

The ability to induce regions of high and low ionic concentrations adjacent to a permselective membrane or a nanochannel subject to an externally applied electric field (a phenomenon termed concentration polarization) has been used for a broad spectrum of applications ranging from on-chip desalination, and bacteria filtration to biomolecule preconcentration. But these applications have been limited by the ability to control the length of the diffusion length that is commonly indirectly prescribed by the fixed geometric and surface properties of a nanofluidic system.

### SUMMARY OF THE INVENTION

The present embodiments may provide a method for spatio-temporal control of the diffusion length that propagates from an ion permselective medium interface and is applicable to any solution regardless of its conductivity. Such control may be provided using electrothermal (ET) flow.

All other known methods of suppressing the diffusion length growth lack the ability to precisely control its length in a dynamical fashion. In contrast, the proposed method provides a direct, precise and dynamical way to control the diffusion length via local stirring of the solution using ET induced vortices. The diffusion length may then be dynamically controlled by turning on/off selected heaters on demand.

According to an aspect of some embodiments of the present invention there is provided a microchannel-membrane device comprising:

first and second electrodes for generating a concentration-polarization layer;

a microchannel extending through at least the first electrode, the microchannel having a predetermined depth;

an ionic permselective medium across the microchannel between the first and second electrodes; and

at least one heater embedded below the microchannel on a first side of the permselective medium.

In an embodiment, the at least one heater comprises an array of heaters embedded below the microchannel at intervals along the first side of the permselective membrane.

In an embodiment, the predetermined depth is greater than 0.3 mm or 0.4 mm, or about 1 mm, or 1 mm, or 1.5 mm.

In an embodiment, the at least one heater comprises an array of thin film microheaters.

In an embodiment, heaters of the array are separately controllable to define heating locations along the microchannel.

In an embodiment, the heaters are controllable to generate an ET-induced vortex, therewith to limit growth of a diffusion length to the first location on the first side, the first side being a depletion side of the membrane.

In an embodiment, the heaters are dynamically controllable to change between heating locations, thereby to move the ET-induced vortex along the microchannel and alter the desired length.

In an embodiment, the at least one heater or array comprises a dielectric coating, thereby to provide an insulation layer.

In an embodiment, the at least one heater or array is controllable to a predetermined frequency.

In an embodiment, the at least one heater or array is controllable to apply varying voltages.

Embodiments may comprise a preconcentrated plug of target biomolecules preformed at the depletion end of the diffusion length.

In an embodiment, the at least one heater or array is controllable to locate the preconcentrated target biomolecules with prefixed probes on a surface of the microchannel, or on the surface of a colloid within the channel.

Embodiments may apply dielectrophoresis, and/or magnetophoresis and/or optophoresis and/or electrophoresis and/or thermophoresis and/or diffusiophoresis forces, with functionalized micro or nanoparticles in order to control their manipulation, thereby to perform an immunoassay.

In an embodiment, the probes are configured to operate via micro or nanoparticle-based antibody/and or molecular probe immobilization.

Embodiments may comprise an array of interdigitated electrodes for trapping the micro or nanoparticles.

In an embodiment, the interdigitated electrodes are pairwise addressable to carry out the dielectrophoresis to trap the micro or nanoparticles.

In an embodiment, the interdigitated electrodes are further controllable by the pairwise addressing to release the micro or nanoparticles after entrapment for further analysis.

In an embodiment, the immunoassay is bead-based.

In an embodiment, the ion permselective medium comprises any of an ion permselective membrane, a Nafion membrane, a fabricated nanochannel, fabricated nanopores, and electrodes that generate faradaic reactions, thereby to induce concentration polarization (CP) in the microchannel.

In an embodiment, the microchannel extends between the first and second electrodes.

In an embodiment, the second electrode is in a side microchannel.

According to a second aspect of the present invention there is provided a method for controlling a location of a concentration-polarization layer within a microchannel-permselective membrane system by:
placing an ionic permselective medium across a microchannel;
applying a voltage across the ionic permselective medium to induce a concentration-polarization layer consisting of both ionic depletion and enrichment diffusion layers over a diffusion region having a length along the microchannel across the membrane in the microchannel; and

inducing a vortex at a predetermined location in the microchannel to limit growth of the diffusion region at the depletion side, thereby to define a location of the concentration polarization layer.

In an embodiment, the inducing a vortex comprises using electrothermal (ET) forcing.

In an embodiment, the ET forcing comprises applying an electric field and inducing temperature gradients.

In an embodiment, the temperature gradients are formed using any of a predesigned heater, a fabricated heater, a fixed heater, dynamically patterned heating using laser illumination, dynamically patterned heating using a combination of laser illumination and photoconductive coating, and heating induced by a chemical reaction, heating induced by magnetism, heating induced by optical radiation and heating induced by electrical fields.

The method may involve dynamically changing the predetermined location by changing or moving the temperature gradients.

In an embodiment, the changing or moving the temperature gradients comprises turning on and off heating elements located across the microchannel.

The method may comprise carrying out the turning on and off in a periodic manner.

The method may comprise carrying out the turning on and off in a shaped manner or a stepwise manner, and/or with varying heating powers.

The method may comprise using a frequency of the turning on and off as a control parameter.

The method may comprise carrying out electrodialysis.

The method may comprise CP-based desalination.

The method may comprise obtaining a preconcentration of target biomolecules at the edge of a depletion layer part of the concentration/polarization region.

The method may comprise preconcentrating functionalized beads for colocation with the target biomolecules just outside the depletion layer.

In the method, the ion permselective medium may be a membrane, or a nanochannel, or a nanopore or an electrode, or a Nafion membrane.

The method may comprise carrying out ionic current rectification (ICR) upon reversal of the externally applied electric field.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1(a) is a schematic view of a microchannel-Nafion membrane device according to the present embodiments;

FIG. 1(b) is a schematic showing electrothermically induced vortices resulting from controlled operation of the microheaters of FIG. 1(a)

FIGS. 2(a) to 2(c) are graphs and a microscope image that illustrate the effect of the ET induced flow of FIG. 1(b) on the depletion layer growth within the membrane-microchannel system (microchannel depth ˜1 mm) for various applied heating powers;

FIGS. 3(a) to 3(d) illustrate a series of V-t responses alongside corresponding microscope images of the device of FIG. 1(a) for various frequencies of the periodic step-wise application of the heater (60 mW) at a constant applied current (720 nA) for generating CP within the 1 mm-depth channel;

FIG. 4 is a simplified schematic diagram of a platform for concentration-polarization (CP)-based on chip desalination, according to embodiments of the present invention;

FIG. 5 is a schematic diagram of a platform with parallel microchannels, each having a diffusion length and a preconcentrated plug of biomolecules at the depleted end of the diffusion length, according to embodiments of the present invention;

FIGS. 6(a) to 6(i) are a series of experimentally measured graphs and corresponding microscopic images illustrating transient depletion in terms of the measured voltage and fluorescent intensity profile for various channel depths and heater power according to the present embodiments;

FIGS. 7(a) to 7(d) are a series of numerically computed graphs that illustrate time evolution of the depletion layer in terms of its salt concentration distribution, c=(c₊+c₋/2c₀) for the cases of: a) no heating; (b) ET only; (c) NC only; (d) combined ET and NC, according to embodiments of the present invention;

FIGS. 8(a) to 8(f) are a sequence of graphs showing characterization of the temperature distribution induced by the embedded heaters and the resulting natural convection and ET flow for a simplified device consisting of a microchannel without a membrane, according to embodiments of the present invention;

FIGS. 9(a) to 9(g) are a sequence of graphs showing numerical simulations and examination of the effect of elevated temperature on the concentration distribution and the V-t response, according to embodiments of the present invention;

FIGS. 10(a) and 10(b) show working principles of an ET-based active control of a CP-based preconcentrated molecule plug within a microchannel-membrane device according to embodiments of the present invention;

FIGS. 11(a)-11(f) are a series of diagrams and graphs which schematically show active control of the preconcentrated plug using a single heater operation in an open microchannel-membrane system according to embodiments of the present invention;

FIGS. 12(a)-12(e) are a series of diagrams and graphs showing dynamic control of the preconcentrated plug using multiple heater operation in an open microchannel-membrane system according to embodiments of the present invention;

FIGS. 13(a)-13(d) are a series of microscope images and graphs showing the dependency of the location of the preconcentrated plug on the applied flow rate (a and b) and voltage (c and d), according to embodiments of the present invention;

FIGS. 14(a)-14(c) are a schematic diagram, microscope images and a graph which show generation of a CP induced molecule preconcentrated plug within a DEP-CP platform according to embodiments of the present invention;

FIGS. 15(a) and 15(b) are a graph showing DEP characterization for biotin-linked particles and a demonstration of CP-preconcentrated effect on particle trapping by DEP, according to the present embodiments, and two microscope images showing DEP with and without CP;

FIGS. 16(a) to 16(d) are diagrams and corresponding microscope images which show three steps of an immunosensing scheme including multiple sample loading/wash steps in a DEP-CP platform according to embodiments of the present invention;

FIG. 17(a) is a schematic diagram showing three separate immunosensing schemes according to embodiments of the present invention;

FIG. 17(b) is a graph with inserted microscope images, indicating a limit of detection of conjugation of biotin-avidin with the various schemes of FIG. 16(a) and FIG. 17(a), and indicating the enhanced detection sensitivity of schemes 2 and 3 using CP-based preconcentration;

FIG. 18 is a peak measured fluorescent intensity as a function of avidin bulk concentrations using the various immunoassay schemes within a DEP-CP platform according to embodiments of the present invention;

FIG. 19 is a simplified diagram that illustrates schematics of the 2D model, including the geometry and boundary conditions used in the numerical simulation for the microchannel domain at the anodic side of the membrane, according to embodiments of the present invention;

FIG. 20(a) is a simplified graph that illustrates direct measurement, using an IR camera, of the heater temperature as a function of applied heating power without electrolyte and by extracting the temperatures from the resulting thermoresistor, with an insert that indicates the linear relation between the resistance of the heater to temperature to calibrate temperature coefficient of resistance (α=0.0025), according to embodiments of the present invention;

FIG. 20(b) is a simplified graph that shows indirect measurement of the maximum temperature in the membrane-microchannel systems with electrolyte using temperature sensitive dye, and an inset that indicates the schematic of measured depths of focal plane z, and the microchannel (d), according to embodiments of the present invention;

FIGS. 20(c)-20(e) show microscopic images and normalized intensity of Rhodamine B fluorescent dye in the microchannels at \tilde{t}=400 s for varying heat powers, following their correlated temperature fields and temperature gradient fields, according to embodiments of the present invention;

FIG. 21(a) is a graph showing current-voltage (I-V) response with a voltage sweep rate of 1 mV/s, where the limiting currents, Iₗᵢₘ, are indicated by dashed lines, according to embodiments of the present invention;

FIG. 21(b) is a graph showing correlation of hum with channel depth;

FIGS. 21(c)-21(e) are graphs showing chronopotentiometric (V-t) response with various currents (0.5, 0.8, 1, 1.2, and 1.5×Iₗᵢₘ) for various microchannel depths;

FIG. 21(f) shows sand time vs. the inverse of the current density squared;

FIG. 22 is a sequence of six graphs showing time evolution of the depletion layer growth (intensity normalized by its bulk value) at the anodic side of the microchannel-membrane interface of the systems relating to FIG. 6(c), FIG. 6(f), and FIG. 6(i) above;

FIGS. 23(a)-23(f) illustrate the effect of ET induced flow on the CP behavior for various applied external currents (0.5, 1, 1, 5, 2, and 3×Iₗᵢₘ) in membrane-microchannel systems with 330 (a, c, e) and 1000 μm-depth (b, d, f), according to embodiments of the present invention;

FIGS. 23(e)-23(f) show the corresponding V-t response;

FIG. 24, is a series of graphs that illustrate time evolution of the depletion layer growth (intensity normalized by its bulk value) at the anodic side of the microchannel-membrane interface of the systems (channel depth 330 μm) as a function of various applied currents with heating according to embodiments of the present invention and without heating for comparison;

FIG. 25 is a series of graphs illustrating a time evolution of the depletion layer growth (intensity normalized by its bulk value) at the anodic side of the microchannel-membrane interface of the systems (channel depth 1000 μm) as a function of various applied currents with heating according to embodiments of the present invention and without heating for comparison;

FIG. 26(a) is a simplified graphs which shows numerically computed temperature fields, according to embodiments of the present invention;

FIG. 26(b) shows numerically computed velocity fields with Helmholtz-Smoluchowski slip velocity and boundary conditions, according to embodiments of the present invention;

FIG. 26(c) is a graph that shows the corresponding chronopotentiometric (V-t) responses to FIG. 26(a) and FIG. 26(b), according to embodiments of the present invention; and

FIG. 27 is a simplified graph illustrating a measured temporal change of the velocity component u within a membrane-microchannel system (d=330 μm, z₁=100 μm) under the application of the heater (60 mW) and constant applied current (375 nA); and inserts showing the corresponding vortices at successive times, according to embodiments of the present invention.

### DESCRIPTION OF SPECIFIC EMBODIMENTS OF THE INVENTION

The present invention, in some embodiments thereof, relates to the dynamic control of polarization layer length in a microchannel-permselective membrane system using electrothermic flow.

A microchannel-membrane device comprises a microchannel extending between two electrodes, the microchannel having a preset depth; a permselective membrane across the microchannel between the electrodes; and a heater, or array of heaters, embedded below the microchannel on one or two sides of the permselective membrane. The heaters that are on the depletion side of the membrane induce a vortex which limits the growth of the diffusion area. Operation of the heaters allows for controlled positioning of the end of the diffusion area.

Herein, we demonstrate that the depletion layer can be dynamically varied by inducing controlled electrothermal flow driven by the interaction of temperature gradients with the applied electric field. To this end, a series of microscale heaters, which can be individually activated on demand are embedded at the bottom of the microchannel and the relationship between their activation and ionic concentration is characterized. Such spatio-temporal control of the diffusion length can be used to enhance on-chip electro-dialysis by producing shorter depletion layers, to dynamically reduce the microchannel resistance relative to that of the nanochannel for nanochannel based (bio)sensing, to generate current rectification reminiscent of a diode like behavior and control the location of the preconcentrated plug of analytes or the interface of brine and desalted streams.

It is noted that the microscale heating is not restricted to microfabricated (commonly using photolithography techniques) elements (commonly made of conductive/metallic coatings to act as resistors) that are predesigned, fabricated or spatially fixed on the microchannel. Instead, the heating can be generated using lasers that can dynamically pattern the heated areas, not requiring passing current through these as the heat is generated from the laser illumination and not from Joule heating. Alternatively or additionally, the process may use a photoconductive layer that turns conductive upon laser illumination and thus enables the dynamic patterning of the electrodes that are used as heaters. This latter process may require the passage of current through these in order to generate heat through Joule heating as the laser illumination only converts the layer from being a dielectric to conductive but is not sufficient for heating. Other heating sources (e.g. chemical components, magnetic etc.) may also apply.

It is also noted that the membrane part is not limited to ion-permselective membranes, e.g. Nafion, but applies to any ion-permselective medium such as nanochannels, nanopores, electrodes etc.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

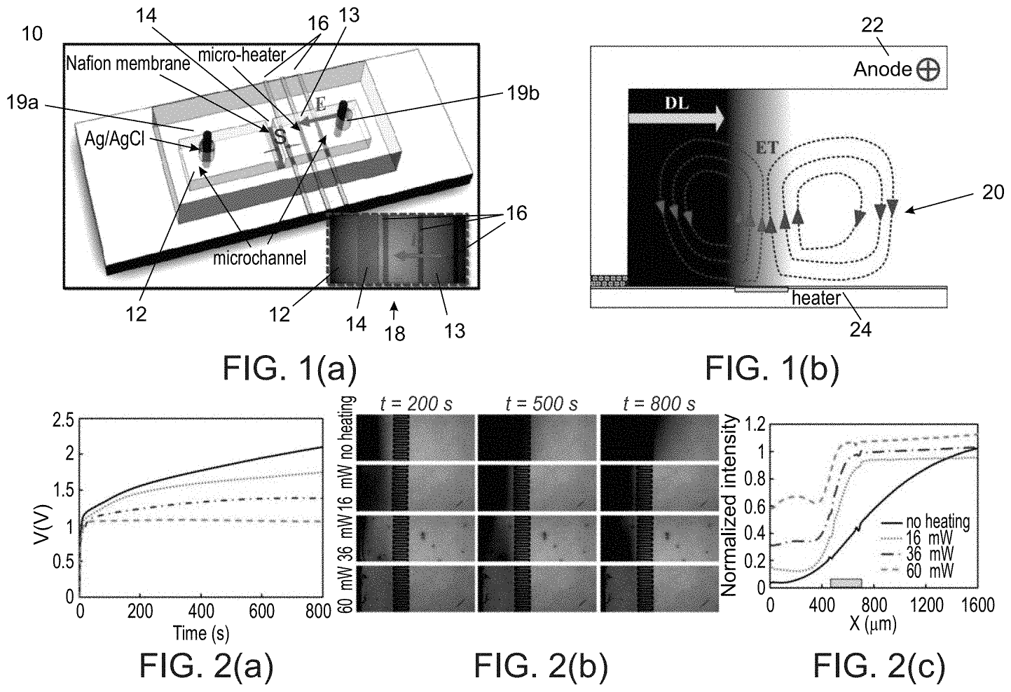

Reference is now made to FIG. 1(a), which is a schematic view of a microchannel-Nafion membrane device 10 according to the present embodiments, which includes microchannels 12 and 13 and a nafion membrane 14, with an embedded array of microheaters 16 for ET stirring. The inset 18 indicates a microscopic image (top view) of a fabricated device. Electrodes 19(a) and 19(b) set a potential across the membrane 14 leading to a diffusion region across the membrane where one side of the membrane has an ionic enrichment region and the other side has an ionic depletion region. According to embodiments of the present invention the microheater array 16 is placed on the depletion side of the membrane 14. However, if one wants to use the device in a dynamically reversed polarization of the external applied field (through electrodes 19) then an array of heaters may be embedded on both channels.

Thus the microchannel-membrane device 10 has first and second electrodes 19a and 19b and a microchannel 12, 13, extending between the two electrodes. The microchannel has a depth which may be optimized as will be discussed below, and 1 mm or anything between 0.4 and 1.5 mm or between 0.75 and 1.25 mm are suitable candidates.

A permselective membrane 14 extends across the microchannel between the first and second electrodes and divides the microchannel into enrichment and depletion sides. At least one heater 16 is embedded below the microchannel on one side of the permselective membrane which, as will be discussed below may advantageously be the depletion side.

The heater 16 is typically an array of heaters, and more specifically microheaters, which are embedded below the microchannel at intervals and may form an array or microarray. The heaters may be thin film microheaters and each element of the array may be coated with a dielectric, as will be discussed in greater detail below. The individual heaters may be addressed to provide accurate control of the location of heating as applied to the microchannel. The local heating is not restricted to fabricated microscale heaters but may be realized by using a laser that dynamically patterns heating sources on the substrate of the microchannel and or may use a photoconductive layer to dynamically pattern conductive heaters. Other methods of generating heat in a temporal-spatial controlled manner are applicable (e.g. chemical, optical, magnetic, electrical etc.).

The heaters or microheaters of the array may be controlled to generate an ET-induced vortex, as will be discussed in greater detail herein below, and the vortices may have an effect on the growth of the diffusion length. Thus, if the vortices can be controlled, then the growth of the diffusion length can be limited to a particular location on the depletion side of the membrane.

In fact, the heater elements may be individually addressable or addressable in groups to dynamically change between heating locations. Thus the ET-induced vortex may be controllably moved along the microchannel as desired, moving the end/edge of the depletion region and altering the diffusion length.

The heater or array may be controlled to a desired frequency and the frequency can be used as a control parameter for the system. Stepwise-varying voltages may be applied over the frequency.

A plug of target biomolecules may be formed at the depletion edge of the diffusion length, as will be discussed below in an embodiment relating to immunoassays.

Reference is now made to FIG. 1(b), which shows schematics of electrothermally induced vortices 20 that are formed according to the present embodiments between an anode 22 and the heater 24, and are able to suppress the growth of the diffusion region at the depletion side, which in turn, determine the depletion layer length.

In use the permselective membrane, for example made of Nafion material, is placed across a microchannel to divide the microchannel into an enrichment and a depletion part. A voltage is applied across the membrane to induce diffusion in a liquid in the microchannel. Diffusion occurs over a diffusion region having a length that would normally increase over the microchannel across the membrane. The diffusion layers are at the opposite sides of the Nafion membrane and may be termed together—concentration-polarization layer.

At this point, the vortex of FIG. 1(b) may be induced as will be discussed in greater detail below. The vortex defines a particular location to which growth of the diffusion region is now limited. The concentration polarization layer is thus restricted to that location.

FIGS. 2(a) to 2(c) illustrate the effect of the ET induced flow of FIG. 1(b) on the depletion layer growth within the membrane-microchannel system (microchannel depth ˜1 mm) for various applied heating powers: FIG. 2(a) shows an exemplary chronopotentiometric (V-t) response at a fixed current regime (1.5·Iₗᵢₘ) of 720 nA; FIG. 2(b) shows time-lapse fluorescent images of the anodic side of the microchannel-membrane interface (x=0); and FIG. 2(c) shows a corresponding normalized distribution, for fluorescent intensity distribution at t=800 s, where normalization is by the bulk value.

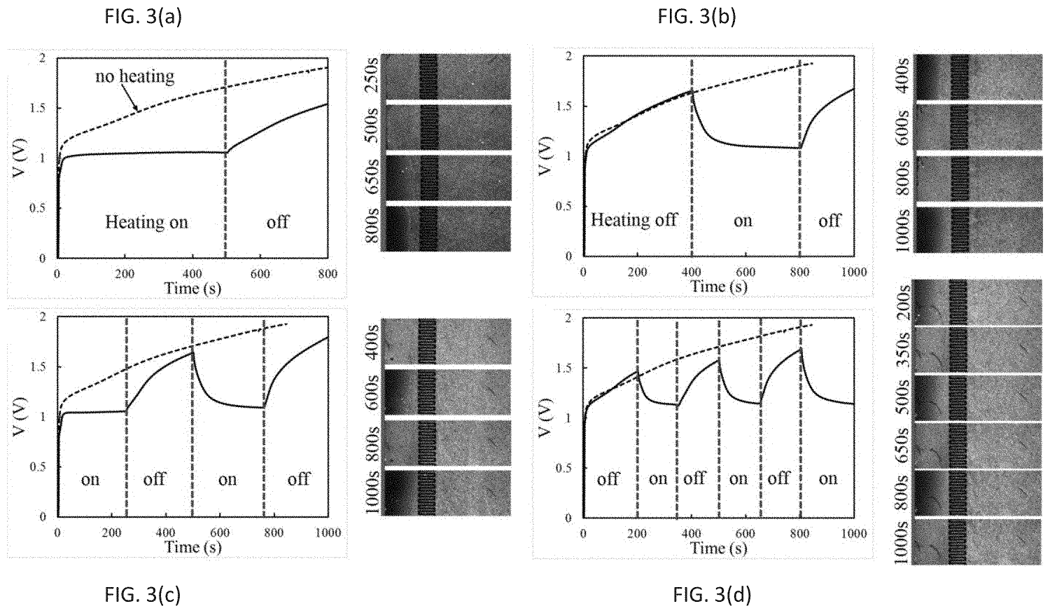

Reference is now made to FIGS. 3(a) to (d), which illustrates a series of V-t responses alongside corresponding microscopic images of the device of FIG. 1(a) for various frequencies of the periodic step-wise application of the heater (60 mW) at a constant applied current (720 nA) for generating CP within the 1 mm-depth channel.

The present embodiments may provide a method for controlling the way in which a concentration-polarization layer forms within a microchannel-permselective membrane system via electrothermal (ET) forcing which results from the interaction of an applied electric field and induced temperature gradients. For this purpose, we have fabricated and tested device 10 which consists of a Nafion-membrane 14 flanked by two PDMS-microchannel 12 and 13. An array of thin film microheaters 16 were embedded at the bottom of the microchannel 13 located on the anodic side of the membrane 14, i.e. on the depletion side. The heaters 16 are electrically insulated by a thick dielectric coating and may generate ET-induced vortices (FIG. 1b). The ET induced vortices can then be dynamically controlled by turning on/off selected heaters on demand. The ET control of the diffusion length was studied by visualizing the concentration-polarization layer via fluorescent dye molecules along with colloid dynamics and measurements of the Chronopotentiometric (V-t) response (FIGS. 2a-c). At a sufficiently deep microchannel (˜1 mm) these flows can actually completely arrest the growth of the depletion layer along with increased concentration within the depletion layer due to increased mixing (FIG. 2b,c). This is manifested also in terms of the resulting system resistance (FIG. 2a) which quickly saturates in contrast to the case of no-heating wherein the system resistance continuously grows in correspondence to the depletion layer growth. Such spatio-temporal control of the depletion layer and also of the associated system resistance is demonstrated in terms of a periodic step-wise application of the heater where the frequency acts as a control parameter of the system behavior, wherein for sufficiently large frequency the depletion layer is not able to recover to the no-heating case and hence limits the system resistance see FIG. 3(c) and FIG. 3(d).

Nafion is a sulfonated tetrafluoroethylene based fluoropolymer-copolymer and the first of a class of synthetic polymers with ionic properties which are called ionomers. Nafion's unique ionic properties are a result of incorporating perfluorovinyl ether groups terminated with sulfonate groups onto a tetrafluoroethylene backbone. Protons on the SO3H (sulfonic acid) groups hop from one acid site to another, and pores allow movement of cations but the membranes do not conduct anions or electrons. Nafion can be manufactured with various cationic conductivities.

Applications (Functions and Possible Commercial Uses and Products)

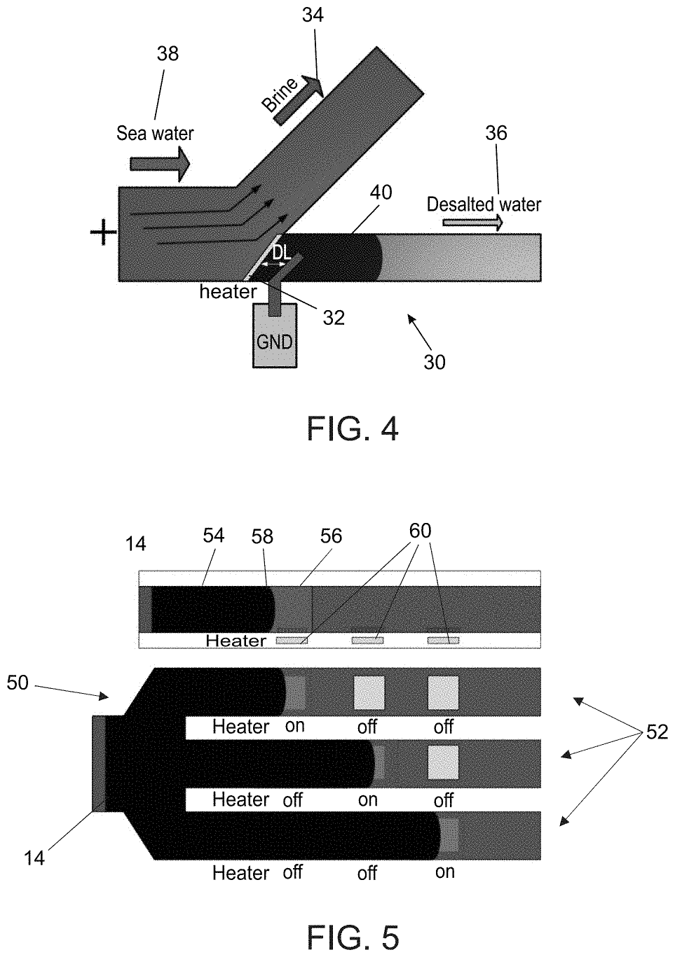

This ET-based spatio-temporal control of the diffusion length may bring new functionalities to concentration-polarization based microscale applications, e.g. controlling the separation between the brine and desalted streams in CP-based on-chip desalination via control of the depletion layer length as shown in FIG. 4, which otherwise is highly sensitive to the system parameters (e.g. applied voltage and flow rate). Another example is controlling the location of the preconcentrated plug of biomolecules that is formed at the edge of the depletion layer due to the field-focusing-gradient effect as shown in FIG. 5, thus, enabling programming of the operation of an immunoassay wherein the location of the preconcentrated biomolecule plug can be dynamically controlled, via the ET effect, to overlap the sensing region (i.e. immobilized antibodies) on the microchannel so as to enhance the binding kinetics and with it also the detection sensitivity.

In greater detail, FIG. 4 is a simplified schematic diagram of a platform 30 for CP-based on chip desalination. An active ET electrode 32 controls the length of diffusion length 40 in the CP-based desalination platform, thus, enabling the accurate separation between brine 34 and desalted streams 36 that are extracted from the incoming seawater 38.

Reference is here made to FIG. 5, which illustrates a platform 50 with parallel (but applies also to a single channel) microchannels 52, each having a diffusion length 54 and a preconcentrated plug of biomolecules 56 at the depleted end 58 of the diffusion length 54. The Nafion membrane is shown as 14. Heaters 60 are shown as on or off and different heater states are applied to the different channels, and as illustrated, the on state of a heater defines an end of the diffusion length. Thus spatio-temporal control may be provided via the heaters of the preconcentrated plug of biomolecules formed at the edge of a depletion layer within a parallel setup of microchannels with immobilized molecular probes at their bottom surface. Such an apparatus may be used for multiplex immunoassay purposes.

### Embodiments—Introduction

The passage of an electric current through a permselective membrane under an applied electric field results in regions of depleted and enriched ionic concentration at opposite ends of the medium, a phenomenon termed concentration polarization (CP). In the low-voltage region, the current-voltage behavior is approximately Ohmic until the diffusion-limited current saturates when both ion concentrations are completely depleted at the surface. The limiting current density scales as the inverse of the diffusion length and for an ideal 1D permselective membrane with negligible convection, the exact relation is i=2zFDc_{∞}/L₁, where z is the valency, F is the Faraday constant, D is the diffusion coefficient, c_{∞} is the bulk ionic concentration and L is the diffusion length. Unless there is some kind of convective stirring in the system, the diffusion length spans the entire distance from the membrane interface to either the electrode or the reservoir. Since the propagation of the depletion layer results in the increase of the system resistance, its chronopotentiometric response shows a monotonic increase of the voltage. Saturation of the voltage occurs when the diffusion reaches its finite length.

In applications requiring intense ion transport, such as electrodialysis, it is desirable to shorten the diffusion length. It has previously been shown that a much faster saturation can be induced in macroscale systems either by natural or forced convection that suppress the diffusive growth, resulting in selection of a smaller diffusion length. At the microscale, scaling arguments suggest that natural convection become less important with decreasing characteristic dimensions, while the use of forced convection is practically complicated since it necessitates incorporating a mechanism capable of applying the external forcing. In a heterogeneous system (i.e., a device which shows any divergence from 1D conditions), the diffusion length may be controlled by “Electro-osmotic flow of the second kind” as a result of the induced electro-convective stirring which can be seen in both fabricated nanochannels and heterogeneous membranes. In both these systems, a significant tangential component of the electric field exists along the membrane interface which serves to drive the ESC that is induced by the normal component of the field. In contrast, for the case of homogenous (i.e. pseudo 1D) permselective systems where there is a negligible tangential field component, in the absence of external stirring, electro-convection emerges only beyond a certain voltage threshold in the form of an electro-convective instability. This electrokinetic instability evolves into a stationary interfacial vortex array that is found to arrest the self-similar diffusive front growth, which in turn specifies the overlimiting current. A competition between these two mechanisms, EOF of the 2^{nd} kind and electro-convective instability, has also been recently shown to control the diffusion length.

In all of the above mentioned cases the diffusion length is indirectly prescribed by the complicated competition between several mechanisms which are primarily dictated by the system parameters and applied voltage. In contrast, the present embodiments may provide a mode of directly controlling the diffusion length, regardless of the dominating OLC mechanism and system parameters, via electrothermal forces. This is realized by the embedding of an electrode array, used as heaters, within the microchannel interfacing a permselective medium. In order to isolate only the electrothermal forces as the active mechanism the electrodes are electrically insulated from the electrolyte via a thick dielectric coating, since for non-insulated electrodes there could be an interplay of induced-charge electrokinetic (ICEK) effect along with bipolar effect.

The former ICEK mechanisms consist of either induced-charge-electroosmosic (ICEO) or alternating-current-electroosmosics (ACEO), both of which arise from the action of the tangential component of an applied electric field over the EDL induced over a polarizable surface subject to an electric field. The distinction is that ICEO is inherent to the system (i.e. non-externally controlled) and occurs over floating electrodes, while ACEO occurs when the electrode's potential is externally controlled. The distinction between these two induced-charge electro-kinetics (ICEK) mechanisms is that ICEO/ACEO may be considered as a “passive”/“active” mode of controlling the CP layer, respectively. In both cases, vortices formed over the electrodes, effectively stir the fluid, arresting the diffusive growth of the depletion region and controlling the limiting and overlimiting currents. It is noted that for the active electrodes, it is possible that ICEO, induced by the DC electric field applied externally across the channel may accompany the ACEO induced over the activated embedded electrodes. Another possible mechanism involves the faradaic (redox) reactions that occur when a sufficiently high driving voltage is applied, causing the electrodes to act as a bipolar electrode (BPE). However, since the ICEO/ACEO stirring mechanism are limited to low conductivity solutions (hence not practical for desalination and/or for biosensing at physiological and/or high conductivity (higher than 1 mM salt concentration) solution) we chose to completely eliminate these effects by coating the heaters/electrodes with an electrically insulating layer. Thus, only the electrothermal effect remains as the dominant mechanism for stirring.

### First Embodiment

Here we study the effect of controlling the concentration-polarization (CP) layer in a microchannel-permselective membrane system via electrothermal (ET) force which results from the presence of temperature gradients. For this purpose, we fabricate and test a device which the ionic permselective medium consists of a Nafion-membrane 14 which is flanked by two PDMS-microchannels 12 and 13 as per FIG. 1(a). An array 16 of thin film microheaters is embedded at the bottom of the microchannel and electrically insulated by a thick dielectric coating to generate the ET-induced vortices shown in FIG. 1(b). The ET induced vortices may then be dynamically controlled by turning on/off selected heaters on demand. The ET control of the diffusion length may be studied by visualizing the concentration-polarization layer via fluorescent dye molecules along with colloid dynamics and measurements of the Chronopotentiometric (V-t) response. Such ET-based spatio-temporal control of the diffusion length may bring new functionalities to concentration-polarization based microscale applications, e.g. on-chip electro-dialysis, separation and preconcentration of analytes. Specifically, depending upon the application controlling may affect the division between the brine and desalted streams in CP-based desalination and the location of the preconcentrated plug of biomolecules developed at the outer edge of the depletion layer in the assay embodiment.

In the present embodiments, the mode of controlling the diffusion length is by driving fluid flow through electrothermal (ET) forces, which result from the presence of temperature—and consequently permittivity and conductivity gradients. The dominance of ET flow at high conductivities and frequencies over ACEO is demonstrated. To the best of our knowledge harnessing ET for control of the CP layer dynamics has not been addressed in the past. In the present embodiment, we provide a verification of the ability to dynamically control the length of the diffusion length using the fabricated membrane-microchannel system of FIG. 1(a), where an array of thin film microheaters are embedded to generate a non-uniform temperature field. The ET-control of diffusion length may be estimated by visualizing the dynamics of the concentration-polarization layer along with colloid dynamics and by measuring the Chronopotentiometric response. The experimental results are qualitatively validated by numerical simulations with a fully coupled two-dimensional (2D) time dependent model. Finally, a dynamic and period control of the depletion layer is demonstrated by turning on/off selected heaters on demand.

FIG. 1(a) shows a schematic of the microchannel-Nafion membrane device with embedded heaters for ET. An array of microheaters is embedded in the microchannel 13 on one side of the membrane. The exemplary microchannel is 3 mm in width and 8.25 mm in length, while the heaters, which may be of serpentine geometry, are 150Ω in resistance, 240 um in length along the microchannel, 20 um in width and S being the spacing between the microheater and the membrane. The inset indicates a microscopic image (top view) of a fabricated device; and FIG. 1(b) is a schematic illustration of the suppression of the diffusion layer propagation by the induced ET flow and natural convection, as discussed above.

Results and Discussion

Characterization of the Temperature Field and ET Flow Due to the Heaters

The heater temperature as a function of the supplied power may be measured both directly, using an IR camera and thermoresister, without electrolyte and indirectly using temperature sensitive dye within the electrolyte. The focal planes (z) for the experiments with electrolyte were 35, 110 and 110 μm at the microchannel with 110, 330 and 1000 μm in depth (d), respectively. The results indicate, as expected, a linear dependency of the heater temperature with the applied power. The temperatures of the electrolyte within the microchannel are slightly higher than those without electrolyte. Also, the temperatures generated by the heater are decreased with increasing distance (i.e. in the z-direction). Increasing heater power may result in increasing heater temperature along with increasing temperature gradients. In order to isolate the ET-generated vortices from EOF, we first evaluate the performance of a membrane-less microfluidic chip under an AC field. Comparing the obtained velocities to those from natural convection (E₀≈0), it seems that the latter contribution is not negligible.

Under a DC applied field where the Coulombic contribution to the ET force is dominant relative to the dielectric contribution, the ET typical stirring velocity (eq.S2) can be approximated as

u_{ET}≈0.5×ε(α−β)E²(∇T),

where ε, σ, E, T stands for the permittivity, the conductivity of the solution, the electric field, the temperature, respectively, and α=(1/ε)(∂ε/∂T)≈−0.4%° C.⁻¹, β=(1/σ)(∂σ/∂T)≈2% ° C.⁻¹. The parameters of the E-field used in the numerical analysis were taken in the same range as those in experiments, while the temperature gradients (3-10 Kmm⁻¹) for the former are four times lower than the experimental values. Experimental ET contribution, u_{ET}, to the velocity beyond that of natural convection, u_{NC}, is in agreement with the numerical predictions for various electric fields and temperature gradients. The resulting Peclet number is 0.3≤Pe_{ET}=u_{ET} d/D≤11, indicating the ET induced vortices may be strong enough to be able to mix the solution nearby. Also, the fact that the quadratic scaling, E₀², yields the best fit, compared to E₀ or E₀⁴, supports the dominance of the ET induced flow due to the combined action of the external electric field and the temperature gradients generated by the heater.

The characterization of the temperature field and electrothermal flow, is now considered in greater detail with reference to the figures.

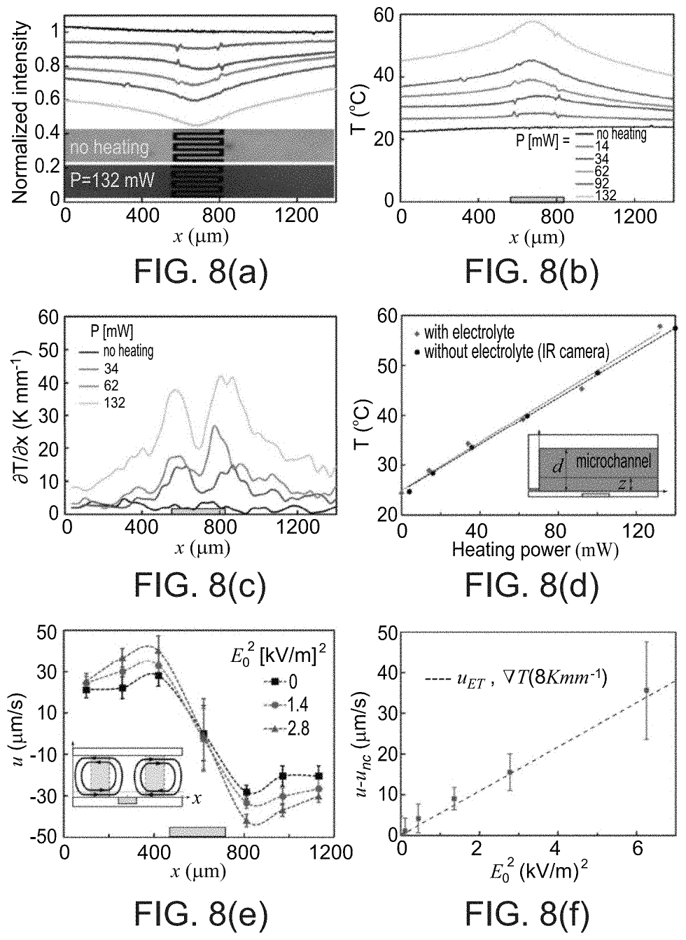

Reference is now made to FIGS. 8(a) to 8(f), which are a sequence of graphs showing characterization of the temperature distribution induced by the embedded heaters and the resulting natural convection and ET flow for a simplified device consisting of a microchannel without a membrane. FIG. 8(a) shows microscopic images and normalized intensity profiles of the rhodamine B fluorescent dye at t=400 s, for varying heater powers, P, within a microchannel (d=1000 μm, z1=100 μm). FIG. 8(b) shows the corresponding correlated temperature and FIG. 8(c) shows temperature gradient distributions. FIG. 8(d) shows the corresponding maximum temperature dependency on the heater power, as extracted via IR camera (without electrolyte) and rhodamine B fluorescent dye (with the electrolyte from part b). The inset presents a scheme of measured depths of focal plane z, and the microchannel, d. FIG. 8(e)shows the measured velocity component along the x-axis, u, within a microchannel (d=400 μm, z1=100 μm) as a function of various applied AC field amplitudes at a frequency of 1 kHz and a fixed heating power of 62 mW. The inset indicates the focal plane (z1=100 μm) and the regions (grey rectangles—located 100-250 μm from the edge of the heater) in which the average velocities were measured. FIG. 8(f) shows the average measured velocity as a function of E₀² (blue markers) and scaling analysis of the ET velocities (eqn (2)). Herein, uNC is the measured average velocity of the natural convection (21±4.7 μm s−1). Quadratic scaling, E₀², yielded the best fit, compared to E₀ or E₀⁴.

More particularly, in order to measure the heater temperature as a function of the supplied power, P, we first characterize indirectly (FIG. 8(a)-8(d)), using a temperature-sensitive dye in the electrolyte, and then directly (FIG. 8(d)), using an infra-red (IR) camera without an electrolyte. The recordings indicate the linear dependency of the heater temperature on the applied power. In order to isolate the ET-generated vortices from linear EOF, we first evaluate the performance of a membrane-less microfluidic chip subjected to an AC field. The velocity profiles, extracted by particle tracking at various z-planes, are shown in FIG. 8(e). A comparison of the measured velocities to those obtained from natural convection (E0≈0) suggest that while the latter contribution is not negligible under the studied conditions, with increasing electric fields, the ET flow dominates natural convection due to its quadratic dependency on the electric field (FIG. 8(f)).

To describe the induced ET flow, the ET force under DC electric field conditions can be expressed as

f_{ET}=½[(α−β)(∇T·E)E−½α|E|²∇T] (1)

where ε=εᵣε₀ is the fluid permittivity (εᵣ is the dielectric constant while ε₀ is the vacuum permittivity), σ, E, T stand for the permittivity and conductivity of the solution, electric field and temperature, respectively, and α=(1/ε)(∂ε/∂T)≈−0.4% ° C.−1, β=(1/σ)(∂σ/∂T)≈2% ° C.−1. It is clear that under DC field conditions, the coulombic contribution (first term) to the ET force is dominant relative to the dielectric contribution. A scaling analysis of the ET velocity, based on the Stokes equation consisting of the ET force (eqn (1)), yields

u_{ET}=0.5ε(α−β)E₀²(∇T)d²η⁻¹ (2)

where d is the height of the microchannel and η is the dynamic viscosity of the fluid. Applying eqn (2) to the experimentally measured ET velocities (FIG. 8f) yields a fitted temperature gradient of 8 K mm−1, similar to the experimentally measured values (6.1-12.3 K mm−1) obtained by averaging the temperatures within a region of 100-250 μm from the edge of the heater operating at 62 mW. The fact that the quadratic scaling, E₀², for the ET velocity, uET (obtained by subtracting the natural convection velocity, uNC, from the measured total velocity) yields the best fit, compared to E₀ or E0⁴, supports the claimed ET-induced flow mechanism that is due to the combined action of the external electric field and the temperature gradients generated by the heater. The respective range of Peclet number 0.8≤Pe_{ET}=u_{ET}d/D≤7 (wherein D is the diffusion coefficient), indicates that the ET-induced vortices may be strong enough to mix the solution nearby and, in turn, modify and possibly suppress the diffusion length growth.

The Effect of ET Flow on the CP Layer

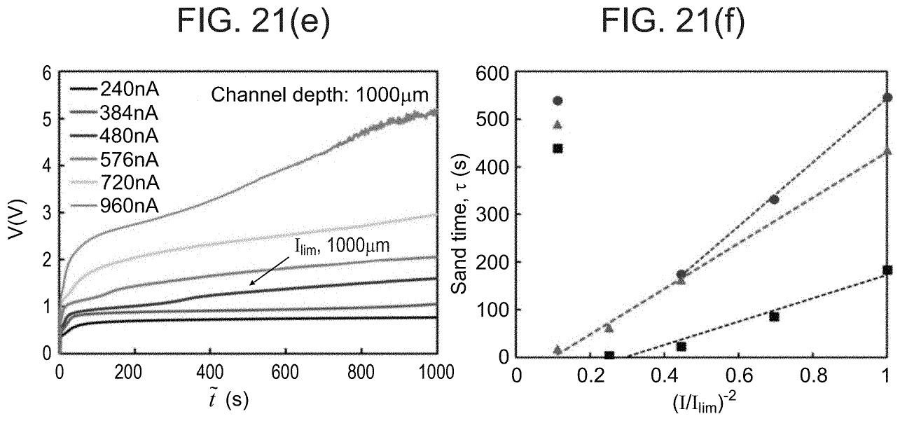

To understand the effect of ET flow on the CP layer we first start by characterizing the microchannel-membrane system without ET flow. As seen in FIG. 21(a) which is discussed more fully below, the limiting currents are proportional to the microchannel depth, FIG. 21(b), whereas the chronopotentiometric response (FIGS. 21(c)-21(e)) of the various systems exhibits the expected inflection point that corresponds to the Sand time and scales with the inverse of the current density squared (FIG. 21(f)).

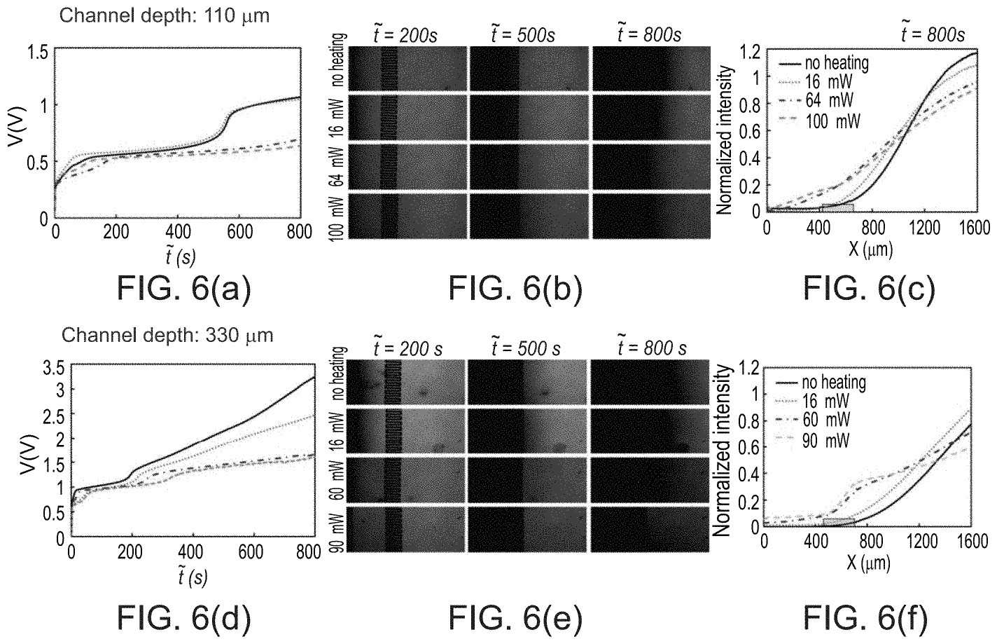

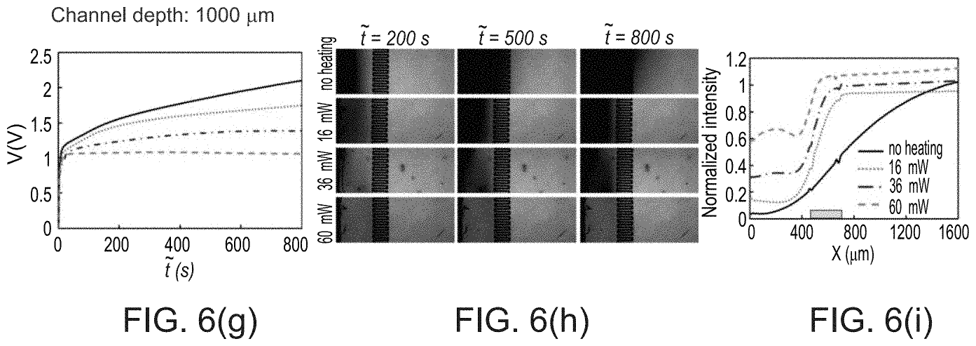

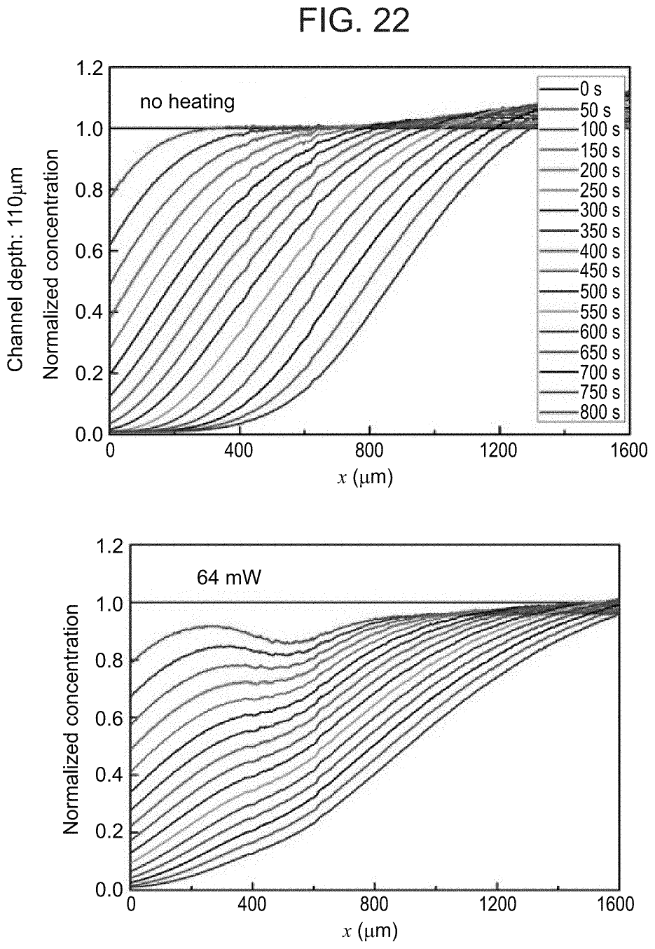

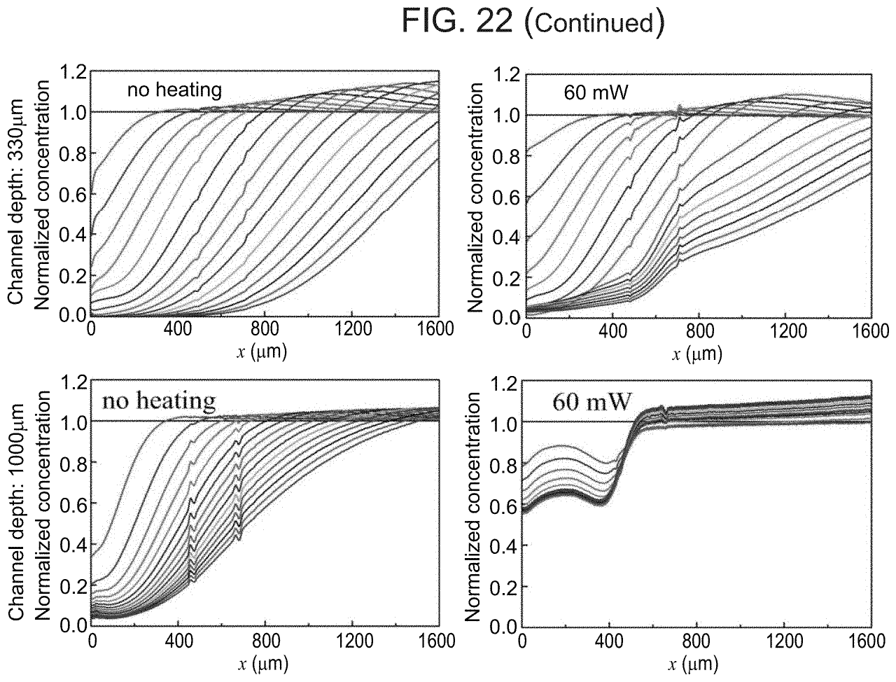

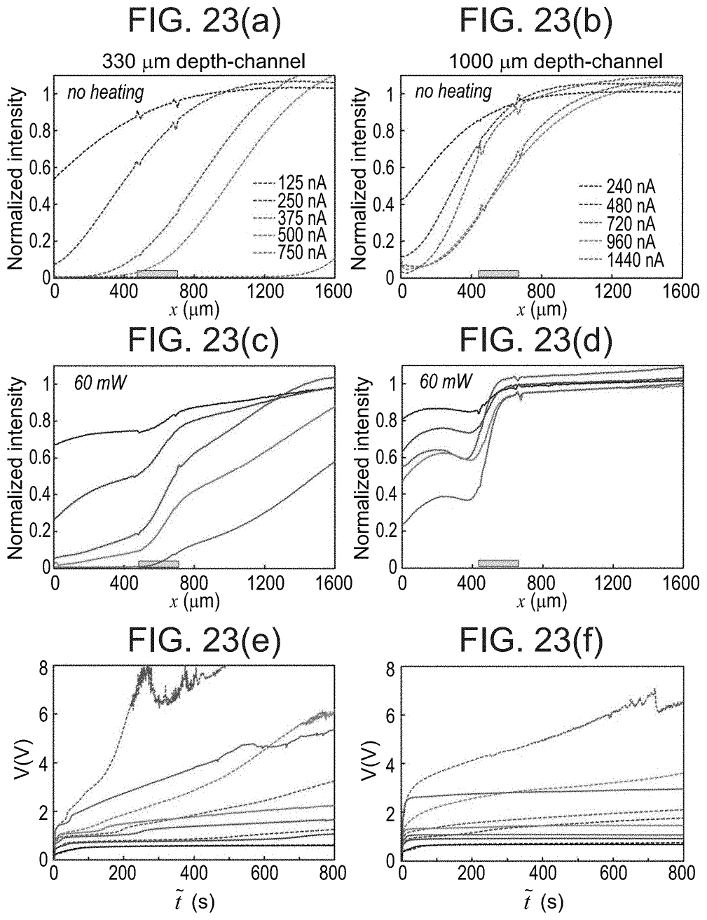

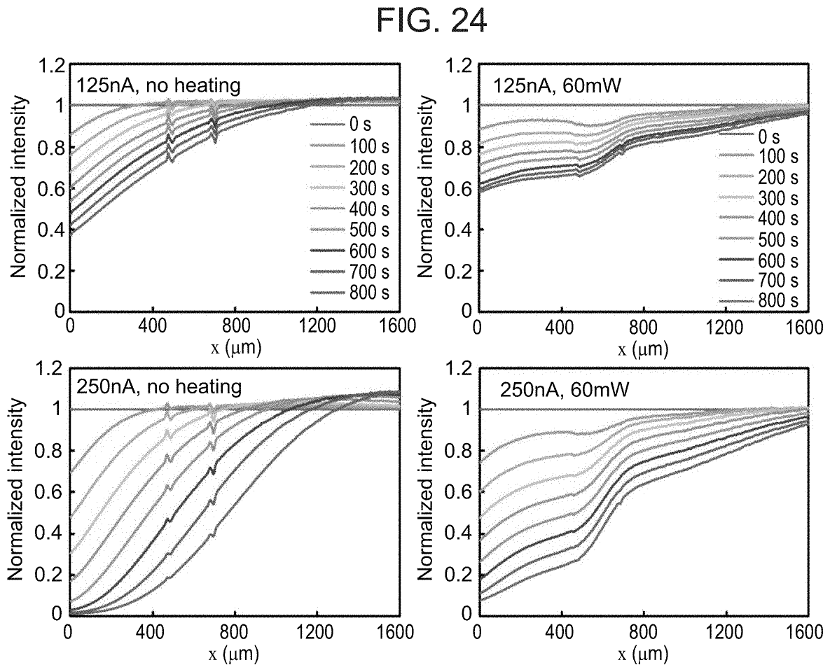

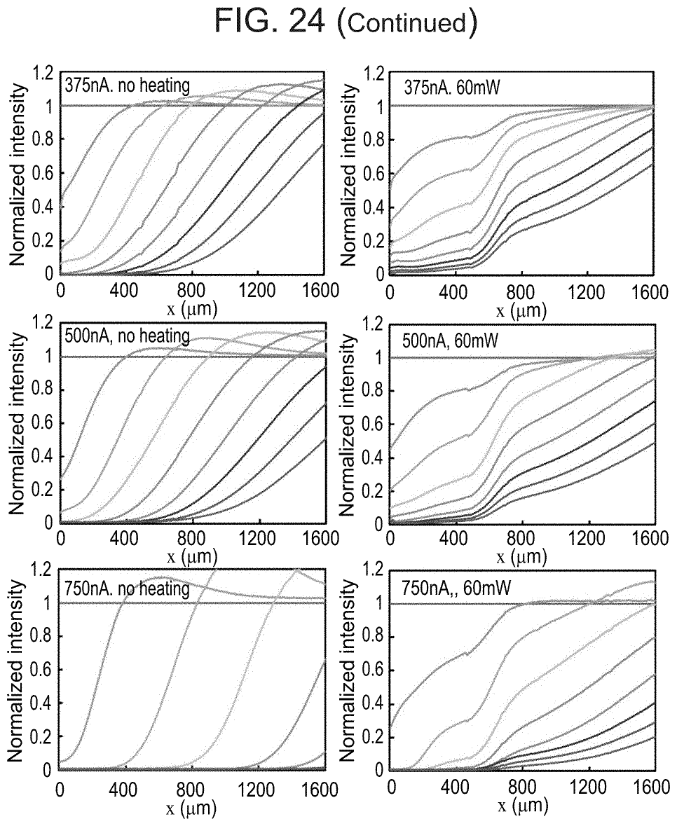

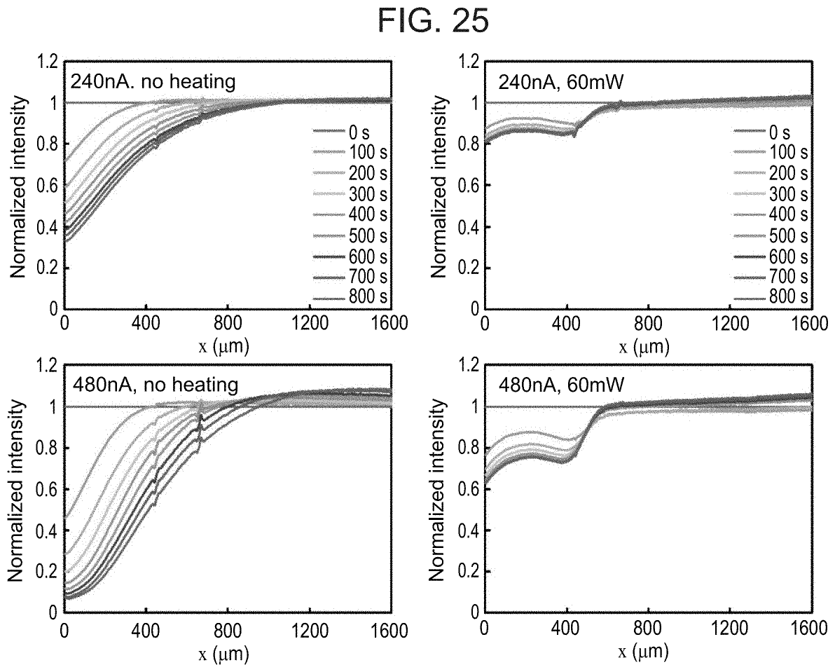

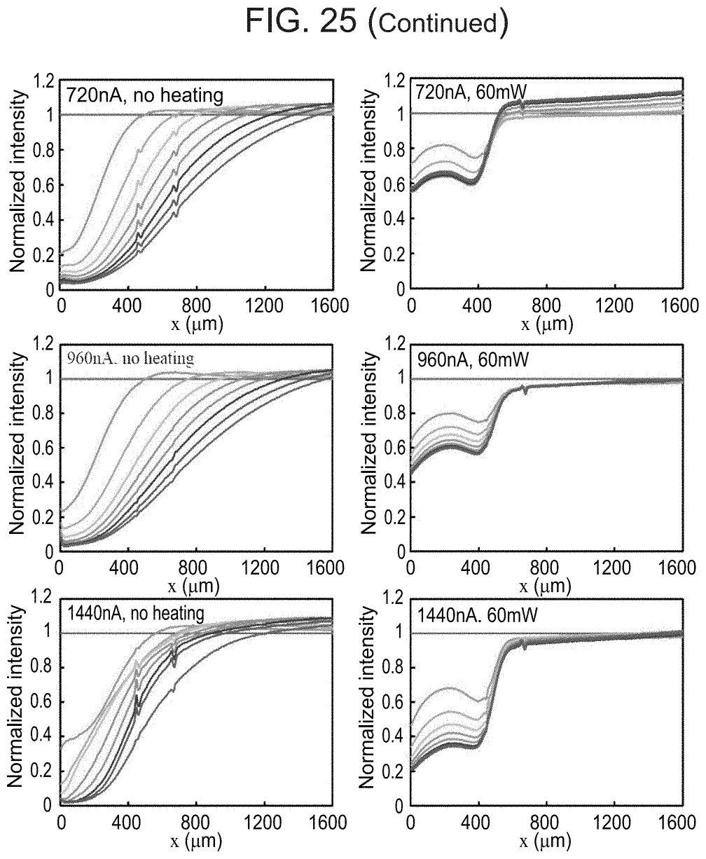

The suppression of the depletion layer growth due to ET induced flow is clearly enhanced with increasing microchannel depth and increasing applied heater power (FIGS. 2(a) to 2(c), FIG. 22). This is most pronounced for the 1 mm depth microchannel FIG. 6(h), FIG. 6(i), whereas for shallower channels, although the depletion layer is affected by the ET flow, its growth is not arrested by the ET flow. As clearly seen in the 1 mm channel—besides arresting the CP growth, increasing the heater power and its associated ET flow, the depleted layer concentration increases due to enhanced stirring. These effects are also exhibited in terms of the chronopotentiometric response of the system. In particular, the continuous propagation of the depletion layer at the shallower microchannels even at the highest heating powers results in corresponding continuous increase of the microchannel resistance, whereas at the 1 mm microchannel and sufficiently high (60 mW) heating power the V-t response saturates very fast (FIG. 22). Increasing the applied currents results in increased depletion —see FIG. 23(a) to FIG. 23(f) whereas for a shallower microchannel it overwhelms the ET effect and results in less effective suppression of the depletion layer growth, as is also shown in the corresponding time-evolution of the depletion layer propagation in FIG. 24 and FIG. 25 for 330 μm and 1000 μm, respectively.

Reference is now made to FIGS. 6(a) to 6(i) which illustrate the effect of the ET induced flow on the depletion layer growth within membrane-microchannel systems with varying microchannel depths, d, for various applied heating powers; FIGS. 6(a, d, g) show chronopotentiometric (V-t) responses at a fixed current regime (1.5·Iₗᵢₘ), which are 75, 375, and 720 nA for 110, 330, and 1000 μm-depth channels, respectively; FIGS. 6(b, e, h) show time-lapse (\tilde{t}=200, 500, and 800 s) fluorescent images of the anodic side of the microchannel-membrane interface (x=0); FIGS. 6(c, f, i) show corresponding normalized (by the bulk value) fluorescent intensity distribution at \tilde{t}=800 s. x=0 which corresponds to the anodic side of the membrane-microchannel interface. As shown, with increasing channel depth the ET flow further suppress the diffusive layer growth.

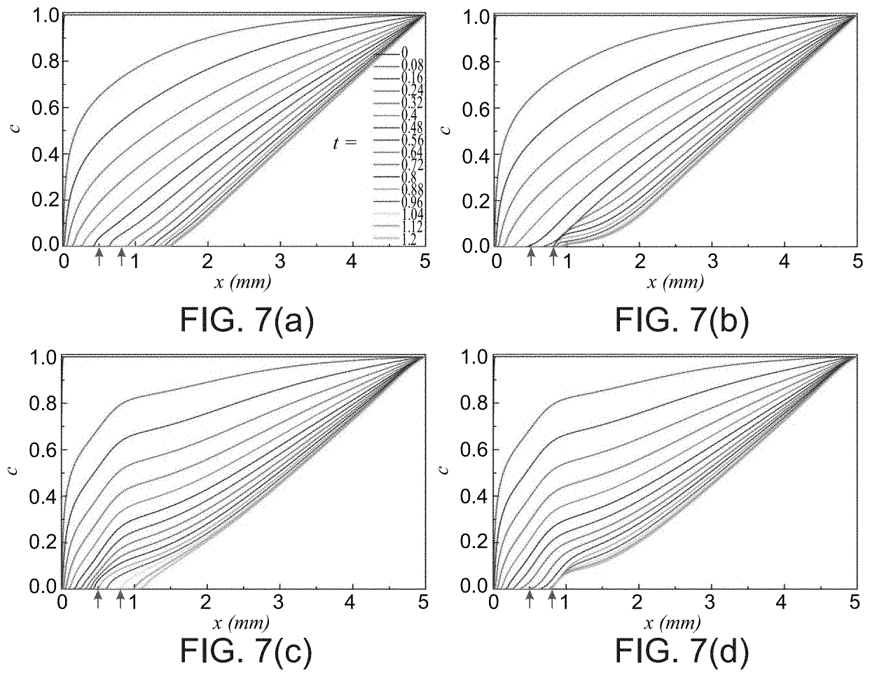

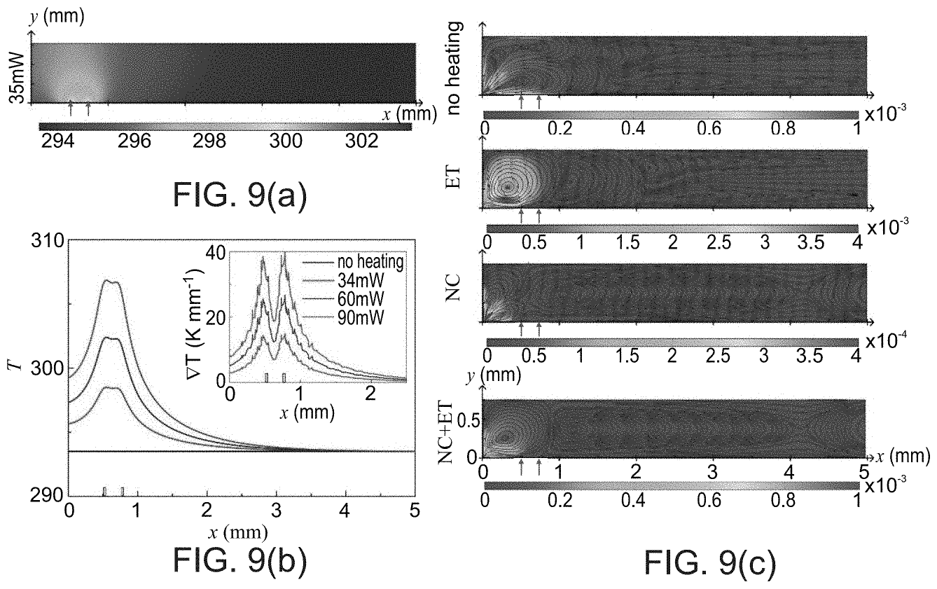

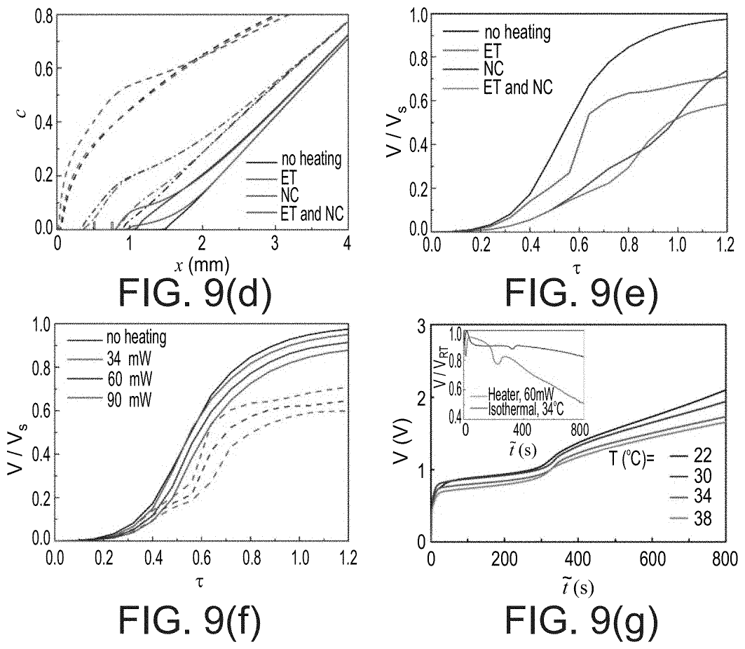

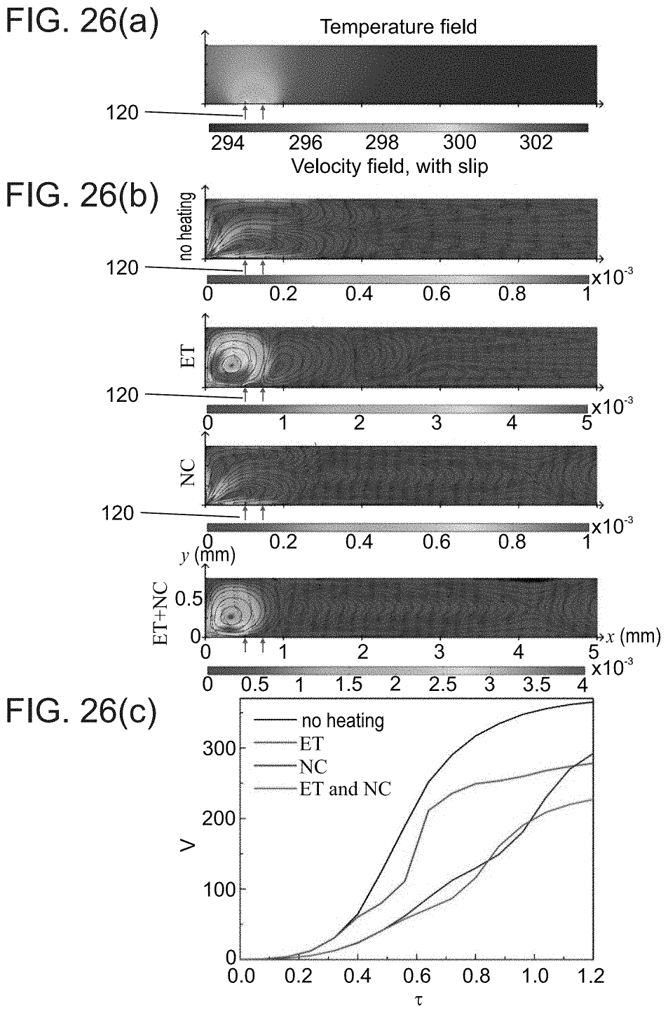

A qualitative understanding of the effect of ET and natural convection (NC) on the depletion region can be obtained using a fully coupled two-dimensional (2D) transient model, by solving the Poisson-Nernst-Planck-Stokes (PNPS) equations along with the energy equation (see in Numerical Simulations for simulation details). The ET- and NC-induced flows were imposed in the Stokes equation as an electrothermal and buoyancy body force respectively, and solved with either decoupled or combined ET and NC effects (FIGS. 7a-d, FIGS. 9a-g). FIGS. 7(a) to 7(d) are a series of graphs that illustrate time evolution of the depletion layer in terms of its salt concentration distribution, c=(c₊+c₋/2c₀) for the cases of: a) no heating; (b) ET only; (c) NC only; (d) combined ET and NC. The applied current density is i=1.45 iₗᵢₘ, 1D (where i_{lim,1D} stands for the limiting current density in the 1D case). In all cases EOF was accounted for by using a zeta potential of ζ=−10 mV. The time, t, is normalized by the diffusion time, \tilde{t}_{d}=L²/D. The solved temperature field, velocity fields, and V-t responses with/without the slip velocity are also shown in FIGS. 26a-c. When considering ET flow only, the depletion layer was only affected when the passing over the heater (FIG. 7(b), FIG. 9(d)), thereby suppressing its growth. This results from the fact that the electric field is inversely proportional to the local concentration (E∝1/c), and hence, increases dramatically within the depletion layer.

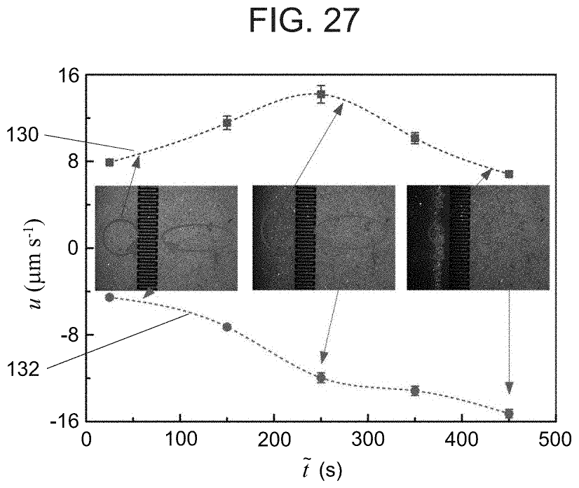

This can be seen nicely in FIG. 27, wherein the vortices associated with the heater increased as the depletion layer approached the heater. When combined with NC, an additive effect on depletion layer suppression was observed (FIG. 7(d), FIG. 9(d)). The numerical results of the temporal CP growth (FIG. 9(d)) were in qualitative agreement with the experimental results of FIGS. 6(a) to 6(i), particularly that of the intermediate channel depth of 330 μm (FIG. 6(f)), wherein suppression of the depletion layer occurred when it overlapped the heater.

The real membrane-microchannel system has more complexity in terms of the associated physical mechanisms than that used to explain the effect of ET flow with scaling arguments. Because the electric field is spatio-temporally non-uniform according to the diffusion length growth, it is hard to obtain experimental ET-induced velocities by the particle tracking method due to absence of colloids in the depletion layer. Also competition between complex mechanisms such as electrophoresis (EP) and ET flow, natural convection, and electro-osmotic flow (EOF) decreases the magnitude of the vortex between the heater and membrane interface and acts as field focusing (See discussion of FIG. 27 hereinbelow).

The effect of electrothermal and natural convection flow on the concentration-polarization layer is now considered in greater detail.

We now return to FIGS. 6(a) to 6(i), which are a series of graphs that show the effect of ET- and NC-induced flow on depletion layer growth within membrane-microchannel systems with varying microchannel depths, d, for various applied heating powers, P.—FIGS. 6(a), 6(d), and 6(g) Chronopotentiometric (V-t) responses at a fixed current regime (1.5/ₗᵢₘ), which were 75, 375, and 720 nA for 110, 330, and 1000 μm-depth channels, respectively. FIGS. 6(b), 6(e), and 6(h) show time-lapse (t=200, 500, and 800 s) fluorescence images of the anodic side of the microchannel-membrane interface (x=0). FIGS. 6(c), 6(f), and 6(i) show corresponding normalized (by the bulk value) fluorescence intensity distribution at t=800 s. As shown, with the increasing channel depth, convective stirring further suppresses diffusive layer growth.

To understand the effect of ET and natural convection (NC) flow on the CP layer, we may begin by characterizing the microchannel-membrane system without heaters. The limiting currents are proportional to the microchannel depth, whereas the chronopotentiometric response of the various systems exhibit the expected inflection point that corresponds to the Sand time and scales with the inverse of the current density squared. The suppression of depletion layer growth due to ET- and NC-induced flow may be clearly enhanced with increasing microchannel depth and increasing applied heater power. This is most pronounced with a 1 mm deep microchannel (FIGS. 6(h) and 6(i)), whereas for shallower channels, although the depletion layer is affected by the ET force and NC flow, its growth is not arrested by the convective stirring. As seen clearly in the 1 mm-deep channel, besides arresting the CP growth, the depleted layer concentration increases with the increasing heater power due to enhanced convective stirring. These effects are also reflected in the chronopotentiometric response of the system. In particular, the continuous propagation of the depletion layer with the shallower microchannels, even at the highest heating powers, results in a corresponding continuous increase of the microchannel resistance, whereas at the 1 mm microchannel depth and sufficiently high (60 mW) heating power, the V-t response saturates very quickly (FIG. 6(g)). Increasing the applied currents results in increased depletion, whereas for shallower microchannels (i.e. 330 μm), it overwhelms the convective stirring and resulted in less effective suppression of depletion layer growth.

A qualitative understanding of the effect of the ET force and NC flow on the depletion region can be obtained by solving the Poisson-Nernst-Planck-Stokes (PNPS) equations along with the energy equation using a fully coupled, two-dimensional (2D) transient model. For simplicity, we also assumed an ideal permselective membrane behavior, thereby neglecting the possible ion selectivity dependence on the applied electric field. The ET and NC-induced flows are imposed in the Stokes equation as an electrothermal and buoyancy body force, respectively, and solved with either decoupled or combined ET and NC effects.

Reference is now made to FIGS. 9(a)-9(g), which are a sequence of graphs showing Numerical simulations and examination of the effect of elevated temperature on the V-t response. FIG. 9(a) Temperature field and FIG. 9 (b) temperature distribution as functions of heating powers (z₁=100 μm) and their corresponding gradients (inset). FIG. 9 (c) shows velocity field for various combinations of convective modes (EOF, NC, ET) at τ=(t/t_{d})=0.72, t_{d}=L²/D. The applied heating power is 34 mW. Black lines and arrows indicate the flow streamlines and velocity vectors, respectively, while the two red arrows point to the locations of the 25 μm-wide heater lines; FIG. 9(d) shows time evolution of the depletion layer in terms of its salt concentration distribution, c=(c₊+c₋)/2c₀ at τ=0.24 (dashed), 0.64 (dashed-dotted) and 1.2 (solid), for the various convective modes. FIG. 9(e) The corresponding normalized chronopotentiometric (V-t) responses by the steady-state voltage at no heating (Vₛ). In all cases, the applied current density is i=1.45i_{lim, 1D} (where i_{lim,1D} stands for the limiting current density in the 1D case) and EOF is accounted for by using a zeta potential of ζ=−10 mV. For the parameters of the diffusion coefficient of ion pairs, viscosity, permittivity and thermal conductivity of a fluid, the temperature-dependent physical properties are considered. A microchannel depth of 750 μm is used in the simulation. FIG. 9 (f) shows a simulated V-t response is shown for varying heating powers, with temperature dependent material properties but without convection (solid lines) and with ET and EOF (dashed lines). FIG. 9 (g) shows the experimental V-t response under isothermal conditions at various elevated uniform temperatures is shown. The inset depicts the voltages (normalized by the value obtained at isothermal 22° C. without heater conditions) measured for the two cases of isothermal conditions (34° C.) without a heater and for a 60 mW heater within the membrane-microchannel system (d=330 μm).

When considering the ET flow, the depletion layer is only affected when passing over the heater (FIG. 9(d)), thereby suppressing its growth. This results from the fact that the electric field is inversely proportional to the local concentration (E∝1/c), and hence, increases dramatically within the depletion layer. The intensity of the vortices associated with the heater increases as the depletion layer approaches the heater. When combined with NC, an additive effect on depletion layer suppression may be observed (FIG. 9(d)), as both act in the same direction (i.e., the resulting vortices are in the same rotational direction, FIGS. 8(e) and 9(c)). The numerical results of the temporal CP growth (FIG. 9(d)) may be in qualitative agreement with the experimental results of FIG. 6(a)-FIG. 6(i), particularly that of the intermediate channel depth of 330 μm (FIG. 6(f)), wherein suppression of the depletion layer occurs when it overlaps with the heater.

To verify that the decreased system resistance, as seen in the V-t response of FIG. 9(e), is due to convective mixing rather than the increased ionic diffusivity resulting from the elevated temperatures, the V-t response of the electro-diffusive temperature-dependent ionic transport in a quiescent fluid is calculated and compared against the V-t response with ET flow (FIG. 9(f)). Although there is a slight voltage drop with increased power in the former cases, the ET flow clearly dominates the voltage drop. To further verify this, experimental V-t responses under isothermal elevated temperatures (without operating the heater but rather using a hotplate) are recorded (FIG. 9(g)). As expected, the uniform increase in the fluid temperature results in a voltage decrease due to the temperature-dependent diffusivity of ions; however the reduction is relatively small and cannot explain the much larger drop associated with ET forces.

Dynamic Control of the CP Layer

To demonstrate the dynamic control of the CP layer via ET-induced flow we use a periodic step-wise application of the heating power (60 mW) at a fixed current (720 nA) for the 1 mm depth microchannel system which exhibits the most pronounced suppression of the CP growth (FIG. 3(a)-FIG. 3(d). This is demonstrated both in terms of the chronopotentiometric response and the corresponding microscopic images of the depletion layer for various time periods where the no-heating case is used as a control. It is clearly seen that when applying heat, the resistance of the system dropped almost to its Ohmic value and the concentration of the depletion layer is significantly increased due to the vigorous ET- and NC-induced mixing. Once the heating is turned off, the concentration within the depletion layer decreases again, together with the continued propagation of the depletion layer away from the membrane interface, resulted in an increase of the resistance (i.e. voltage increase). With increasing frequency of the current signal there is less time for the depletion layer to recover to the no-heating case as clearly seen in the chronopotentiometric response.

FIGS. 6(a)-6(i), discussed above, shows an exemplary V-t response along with its corresponding microscopic images for various frequencies of the periodic step-wise application of the heater (60 mW) at constant applied current (720 nA) for CP within the 1 mm-depth channel.

It may thus be demonstrated that ET-induced flow, which results from the combination of the externally applied electric field and the temperature gradients generated by local heaters embedded at the microchannel surface, combined with natural convection, can effectively modulate the response of the microchannel-membrane system via its mixing/stirring effect of the depletion layer. In a sufficiently deep microchannel (˜1 mm) these flows can actually completely arrest the growth of the depletion layer along with increased concentration within the depletion layer due to increased mixing. This is manifested also in terms of the resulting system resistance which quickly saturates in contrast to the case of no-heating wherein the system resistance continuously grows in correspondence to the depletion layer growth. Such spatio-temporal control of the depletion layer and also of the associated system resistance is demonstrated in terms of the periodic step-wise application of the heater where the frequency acts as a control parameter of the system behavior, wherein for sufficiently large frequency the depletion layer is not able to recover to the no-heating case and hence limits the system resistance. Such spatio-temporal control of the depletion layer may be used for on-chip electrodialysis and CP-based desalination where the division between the brine and desalted streams can be controlled via an array of heaters. It can also allow control of the location of the preconcentrated plug of biomolecules at the outer edge of the depletion layer in immunoassays.

Dynamic control of the concentration-polarization layer is now considered in greater detail. As discussed above, to demonstrate the dynamic control of the CP layer via ET induced flow, a periodic step-wise heating power (60 mW) is applied at a fixed current (720 nA) for the 1 mm depth microchannel system, which exhibits the most pronounced suppression of CP growth (FIGS. 6a-i). It is noted that in addition to a step-wise shape, any other periodic shape could be substituted. We return in this connection to FIGS. 3(a) to 3(d) which show dynamic control of the CP layer and V-t response along with its corresponding microscopic images for various frequencies of the periodic step-wise application of the heater (60 mW), at a constant applied current (720 nA) for CP within the 1 mm-depth channel. Thus the suppression is measured both in terms of the chronopotentiometric response and the corresponding microscopic images of the depletion layer as shown in FIGS. 3(a)-3(d) for various periods, with the no-heating case serving as the control. It is seen that when applying heat, the resistance of the system drops almost to its Ohmic value and the concentration of the depletion layer is significantly increased due to the vigorous ET- and NC-induced mixing. Once the heating is turned off, the concentration within the depletion layer decreases again and, together with the continued propagation of the depletion layer away from the membrane interface, results in an increase in the resistance (i.e., voltage increase).

With the increasing frequency of the current signal, there is less time for the depletion layer to recover to the no-heating status, as clearly seen in the chronopotentiometric response.

It may thus be demonstrated that ET-induced flow, resulting from a combination of an externally applied electric field and temperature gradients generated by local heaters embedded at the microchannel surface, combined with natural convection, can effectively modulate the response of a microchannel-membrane system via its mixing/stirring effect of the depletion layer. At sufficiently high microchannel depths

(˜1 mm), these flows can fully arrest the growth of the depletion layer, along with increased ionic concentration within the depletion layer, due to increased mixing. This is also manifested by the resulting system resistance, which rapidly reaches saturation, in contrast to the no-heating case, wherein the system resistance continuously grows in correspondence to depletion layer growth. In addition, it is shown that a periodic step-wise application of the heater, with the frequency as a control parameter, enables control of the depletion layer and of the associated system resistance. At a sufficiently high frequency, the depletion layer is unable to recover to the no-heating status and hence limits the system resistance.

Such novel spatio-temporal control of the depletion layer is expected to be of utility in on-chip electrodialysis, where it is desirable to shorten the diffusion length for intense ion transport, and CP-based desalination where the division between the brine and desalted streams can be controlled via an array of heaters. It can also allow for control of the location of a preconcentrated plug of biomolecules at the outer edge of the depletion layer in immunoassay applications. Furthermore, asymmetric actuation and/or integration of the array of heaters at opposite sides of the membrane (e.g., as

in FIG. 1(a), where one side is bare while the other has an array of heaters) leads to ionic current rectification (ICR) upon reversal of the externally applied electric field, i.e. a nano-fluidic diode like behavior. In contrast to other mechanisms of rectification resulting from the asymmetry of the permselective medium itself (e.g., asymmetric geometry as in nanopore or funnel-shaped nanochannels) the current mechanism is the direct consequence of the asymmetric depletion layer.

However, in contrast to previous studies of the latter mechanism, wherein the current rectification value is determined by the system fixed geometry, the current ET-controlled CP enables a dynamic variation of the rectification (see FIGS. 3(a)-3(d)) as well as higher values of rectification due to enhanced control over the contrast between the CP responses at the opposite sides of the membrane.

Methods

Chip Fabrication

The device (FIG. 1(a)) consists of a straight Nafion membrane 14 (3 mm in width, 1 mm in length) flanked by two polydimethysiloxane (PDMS) microchannels (3 mm in width, 8.25 mm in length) 12 and 13. Herein, we keep the rectangular microchannels constant in size while the depth is varied. The design is similar to previously studied microchannel-Nafion interface devices, while an embedded electrode array is substituted with a micro heater at one side of the microchannel. The patterned micro-heater supplies an external heating source in the system to generate temperature gradient, which is independent of the applied electrode field for CP generation. The faradaic reactions or other electrochemical reaction above the heater are fully suppressed by coating multi-stacked electrical insulating layers using silicon oxide/silicon nitride (0.5 μm/1 μm in thickness). The opposite microchannel is left bare as a control to study I-V characterization.

Experimental Setup

Two Ag/AgCl electrodes 19a and 19b, 0.38 mm in diameter (A-M systems) are inserted within each reservoir (1.5 mm in diameter with its center located at the end of the channels which are ˜8 mm from the membrane interface) and connected to Gamry reference 3000 for the CP generation. Chip wetting and cleaning prior to experiments may be required. The electrolyte used in all experiments is around 1 mM KCl (σ=108 μS/cm, pH=6.13). The current-voltage (I-V) curves are obtained from linear sweep voltammetry with a slow sweep-rate at a sweep-rate of 0.1V every 100 s from 0 to 3V. For ionic concentration profiles, 10 μM concentrations of pH-free dylight molecules (Dylight 488, Thermos Scientific) are mixed in the KCl electrolyte. Their measured fluorescent intensity is further analyzed by normalizing the concentration intensity of the plateau away from the interface. The microheater 16, connected to a DC power supply (Agilent 3612A) is activated with various heating powers or with various starting times to examine the electrothermal effects. The electrothermal induced velocities are tracked by using 2 μm-florescent particles (Thermo Scientific) of 0.01% volumetric concentration. All experiments are recorded with a spinning disc confocal system (Yokogawa CSU-X1) connected to a camera (Andor iXon3). A temperature field above the heater without electrolyte is monitored using an infrared camera (optris PI 450, Optris). Additionally, the maximum temperature of the heater is extracted from a linear approximation of the resistance of the heater versus temperature, R(T)=R(T₀)(1+α(T−T₀)), where R(T) and R(T₀) are the resistance values at a temperature T and T₀, respectively, and a is the temperature coefficient of resistance. The local temperature distributions above the heater within the electrolyte are measured using a fluorescent dye (rhodamine B, Sigma) of 10 μM concentrations within the KCl electrolyte.

The above experiment thus provides a mode of active control of the diffusion length that resolves the above-mentioned deficiencies, by driving fluid flow through electrothermal (ET) forces. These result from the interaction between the electric field and temperature gradients (i.e. permittivity and conductivity gradients). The mode is realized by embedding an array of thin film microheaters within the microchannel, and setting up a permselective medium (FIG. 1(a) across the microchannel. Heaters 16 may be placed on one or both sides of the medium to generate a non-uniform temperature field. In order to actively drive electro-convection by the electrothermal forces only, the electrodes are electrically insulated from the electrolyte via a thick dielectric coating.

The dominance of the ET flow at high conductivities and frequencies over ACEO has been demonstrated. In addition, the insulation layer suppresses unwanted faradaic reactions.

Finally, dynamic and periodic control of the depletion layer may be demonstrated by turning selected heaters on or off on demand. Such a spatio-temporal control of the depletion layer may be of utility in on-chip electrodialysis and CP-based desalination and molecule preconcentration applications as mentioned above.

### Embodiment 2

Embodiment 2 relates to electrothermal spatio-temporal control of biomolecule preconcentration for sensitive immunoassay and provides a practical demonstration of how biomolecules are concentrated at the end of a controlled diffusion length such as that of the first embodiment. Thus a user is enabled to place biomolecules where they are wanted.

Concentration-polarization (CP) based biomolecule pre-concentration is important for enhancement of the detection sensitivity of target biomolecules in immunoassay-like tests. However, the main deficiency of the prior art systems is the inability to precisely and dynamically control the location of the pre-concentrated plug of biomolecules to overlap the surface immobilized molecular probes. In the present embodiment local electrothermal (ET) stirring provides a way to control the location of the preconcentrated biomolecule plug. For that, the microfluidic device consists of a Nafion membrane to induce the CP, and an array of individually addressable microscale heaters. The experimental results demonstrate that such a platform enables to dynamically overlap the functionalized microparticles with the preconcentrated plug for enhanced detection sensitivity and binding kinetics. An increased efficiency is obtained for the platform using avidin-biotin particle conjugation as a simple model for bead-based bioassay.

A property of ion exchange membranes is their ion permselectivity stemming from the charged surface groups which allow predominantly counterions to pass through unimpeded while co-ions are excluded due to electrostatic repulsion. Under non-equilibrium conditions, i.e. application of an external field, this symmetry breaking phenomenon results in the formation of ionic depleted and enriched layers at the opposite membrane-electrolyte interfaces, a phenomenon known as concentration-polarization (CP). The ability to induce regions of high and low ionic concentrations adjacent to a permselective membrane or a nanochannel subject to CP has been the focus of intensive research in the last decade, particularly regarding its relation to microfluidic applications, e.g. on-chip desalination where the CP layer is used to separate between brine and desalted streams, or enhanced immunoassay sensing by preconcentration of analytes at the edge of the depletion layer. Among various applications, a CP-based preconcentration where the preconcentrated plug of the analyte occurs at the outer edge of the depletion layer due to counteract convective versus electromigrative ion fluxes, brings a great interest in immunoassay field enhancing the sensitivity from dilute samples up to a million-fold. Recently various nanofluidic preconcentration systems have been investigated using various permselective materials such as nanochannel, porous membrane and polyelectrolytic gel to achieve more sensitive detection.

The ability of a CP-based preconcentration system to continuously accumulate the charged molecules of the sample solution onto desired locations enables to integrate both surface and bead-based immunoassay. Ko et al. reported a preconcentrator-enhanced surface-based immunoassay using C-reactive protein where the capturing antibodies were immobilized onto the patterned surfaces and the targeting proteins were preconcentrated above the pattern by CP. Wang and Han also demonstrated bead-based immunoassay with CP-based electrokinetic preconcentration where the antibodies linked to the nanoparticles are hydrodynamically trapped in narrow gaps. However, the main deficiency in CP-based preconcentration system is the inability to precisely and dynamically control the location of the preconcentrated plug. Such ability is extremely useful in overlapping between the preconcentrated plug of target molecules and the location of the functionalized antibodies for enhanced detection sensitivity.

The present embodiments may address the above issues by providing a mechanism of active control of the diffusion length by inducing controlled electrothermal flow. ET-induced flow, which results from a combination of an externally applied electric field and temperature gradients (i.e. permittivity and conductivity gradients of the electrolyte) may be generated by local heaters embedded at the microchannel surface that can effectively modulate the concentration distribution of the depletion layer via local ET stirring. Such spatio-temporal control via ET force with an individually addressable microheater array can be potentially used to control the location of the plug and its preconcentration intensity.

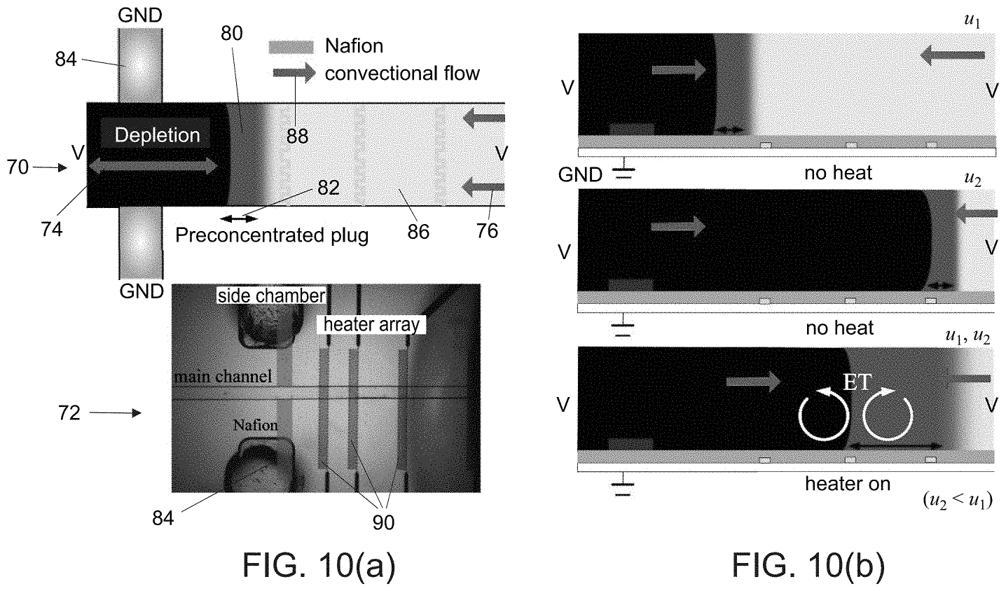

Hence, in the present embodiments, we integrate the function of electrothermal flow (ET) into a CP-based preconcentration system to dynamically manipulate the functionalized particles and to precisely control the location of preconcentrated plug, respectively. For this purpose, we fabricate a platform (FIGS. 10(a) and (b)) consisting of an open microchannel-membrane system which supports a net flow between the two opposite anode-microchannel inlets interconnecting a perm-selective Nafion membrane for forming analyte preconcentrated plug by CP with an array of individually addressable thin film microheaters that are embedded at the microchannel surface. As a proof of concept for bioassay, biotin-avidin conjugation is used to demonstrate the efficiency of the system. Such a platform enables to dynamically overlap the preconcentrated plug over locations of surface immobilized molecular probes (e.g. bead-based or patterned on the microchannel surface) for enhanced detection sensitivity and binding kinetics.

In greater detail, FIGS. 10(a) and 10(b) show the working principle of the ET-based active control of a CP preconcentrated plug within a microchannel-membrane device. FIG. 10(a) is a schematic 70 and a microscopic image 72 of a fabricated device. The red 74 arrows indicate depletion layer length at upstream channel 78 and the blue arrows 76 indicate the direction of the counteracting convective flow, respectively, that are necessary for a preconcentration plug 80 whose length is indicated by arrow 82. Membrane 84 sits across the head of microchannel 86 and convectional flow is in the direction of arrow 88. Based on the convectional flow the microchannel 86 is considered to be upstream of the membrane 84. Underlying the channel is heater array 90.

FIG. 10(b) is a schematic illustration of ET induced control of the location under different conditions of convective flows, u₁ and u₂, which represents the preconcentrated plug being either downstream or upstream of the target location without active heaters and with active heaters. In the case of active heaters the convective flows control the extent of the depletion and thus the position of the preconcentrated plug.

### Active Control of the Preconcentrated Plug by ET Stirring Using a Single Heater Operation

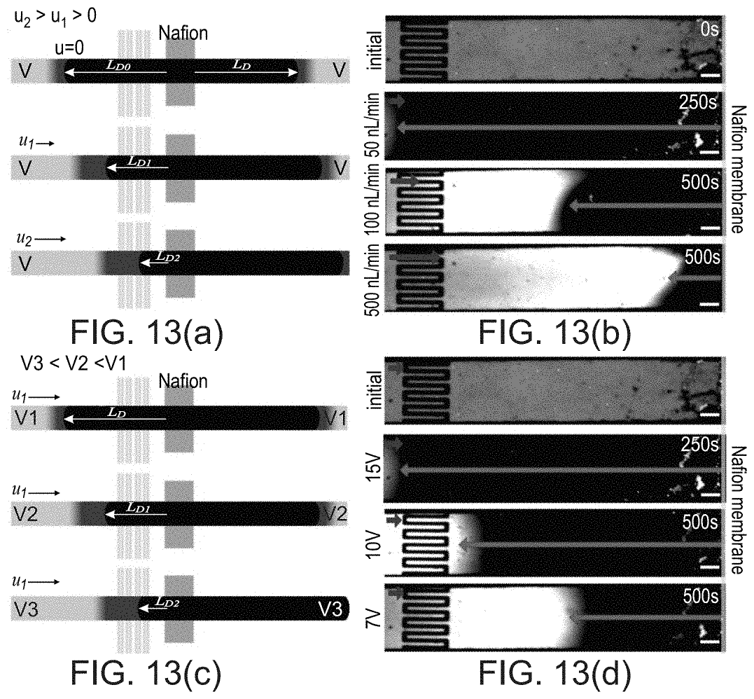

Without applying net convection though the microchannel the application of the same voltage at its extreme ends may result in a symmetric propagation of the depletion layer without the formation of pre-concentrations plugs. However, the existence of advection in the system causes a formation of a preconcentrated biomolecule plug at the edge of the depletion layer upstream of the Nafion interface due to field-gradient-focusing effect by counteracting advection and electromigration (see FIG. 10a). For a certain microchannel geometry and ionic strength, the length of the depletion layer, which in turn dictates the location of the preconcentrated plug at its edge, strongly depends on the applied flow rate and the electric field (FIG. 13(a)-FIG. 13(d)).

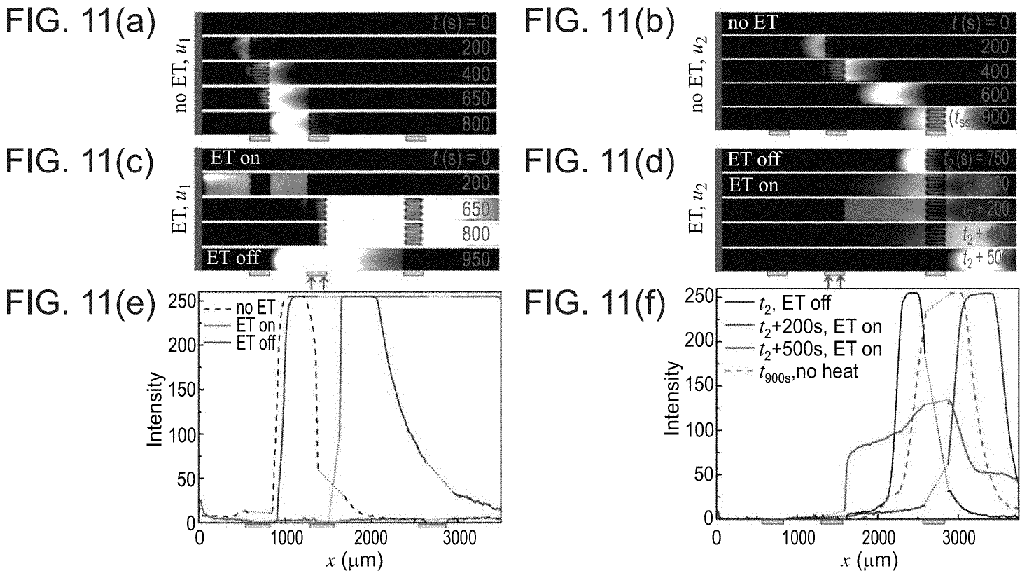

In order to precisely control of the location of the preconcentrated plug, we use ET induced-flow to control the depletion layer spatio-temporally by turning on/off local heaters embedded within the microchannel. For example, without any applied heaters the equilibrium location of the preconcentrated plugs for u₁ and u₂ (u₁>u₂) flow is either downstream or upstream of the 2^{nd} heater (FIG. 10b). By activating ET flow on the 2^{nd} heater, the preconcentrated plug is relocated with one of its edges close to the active heater in both cases. To demonstrate the illustrated concept (FIG. 10(b)), ET flow using single heater operation is induced during the CP activation to control the preconcentrated fluorescent molecules at the target location between the 2^{nd} and 3^{rd} heaters. The constant voltage (30V) for CP is applied at both reservoirs of the main channel, which results in propagation of the depletion layer beyond 4 mm at the upstream channel under the no convection flow condition. When the convective flow of u₁ and u₂, which are 500 (Pe=486) and 300 nL/min (Pe=292) is applied, the depletion layer and its associated plug is either located downstream of the 1^{st} heater or upstream of the 2^{nd} heater, respectively (FIG. 11(a), 11(b), 11(e), 11(f)).

In the cases of u₁ and u₂ flow, the 2^{nd} heater (120 mW) is activated at different times, i.e. when the external field for CP generation is applied (t₀=0 s) or when the preconcentrated plug passes the 2^{nd} heater (t₂=750 s). In the case of ET with uᵢ, the preconcentrated plug relocates to the center of the activated heater and expands at least 2 mm due to introduction of a high convective flow (FIG. 11c, e). In the case of ET with u₂, the preconcentrated plug that has already passed the 2^{nd} heater is pulled back to the activated heater temporary (˜200 s) and eventually moved back to its equilibrium location without active heaters, upstream of the 2^{nd} heater (FIG. 11d, f). These results may demonstrate that activation of the ET stirring enables control of the location of the preconcentrated plug.

In greater detail, FIGS. 11(a)-11(f) show active control of the preconcentrated plug using a single heater operation in an open microchannel-membrane system. FIGS. 11(a) and 11(b) are time-lapse images showing the preconcentrated plug built at different locations without ET activation under convective flow u₁ and u₂ respectively; FIGS. 11(c) and 11(e) are time-lapse images and their related intensity profiles showing the expansion and relocation of the preconcentrated plug under the convective flow u₁ or (d, f) u₂ after turning on the 2^{nd} heater. The red arrows and yellow rectangles indicate the activated heater and the location of the heaters, respectively.

### Dynamic Control of the Preconcentrated Plug Using Multiple Heaters Operations

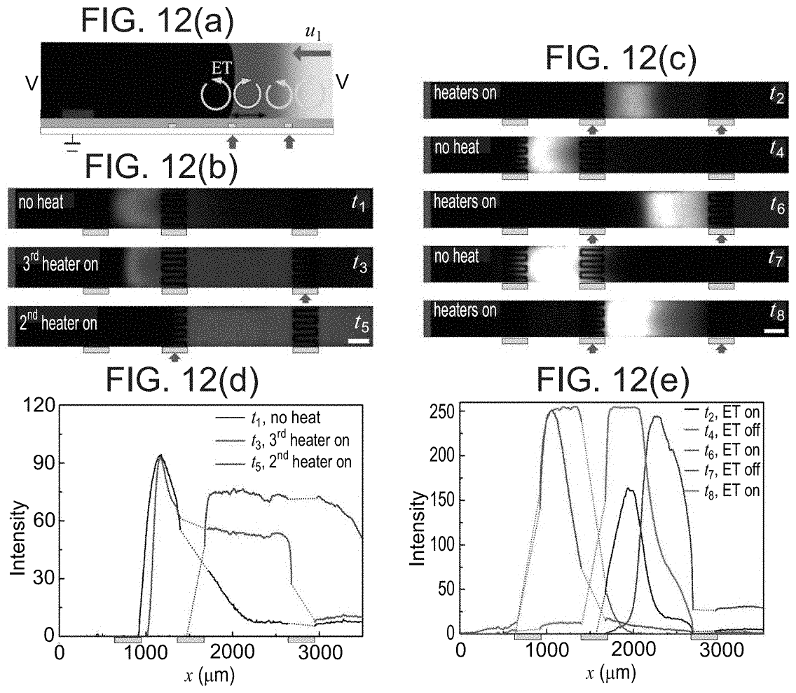

To demonstrate the dynamic control of the preconcentrated plug via ET-induced flow a step-wise heating power (120 mW) is applied at either a single heater at different locations or two heaters operation at a constant voltage (30 V) and convective flow (Pe=430) (FIG. 12b). In order to understand resulting preconcentrated plugs under several heat operations better, the transient images and corresponding intensity profiles are separated according to single heater operation with different location (FIG. 12(b), FIG. 12(d) or two heater operation (FIG. 12(c), FIG. 12(e)).

It may be seen that when applying single 2^{nd} or 3^{rd} heater separately (FIG. 12b), the preconcentrated plug is either relocated upstream of the 2^{nd} heater or restricted to downstream of the 3^{rd} heater due to the enhanced mixing of its upstream side with bulk solution. Interestingly, when the two heaters are simultaneously activated (FIG. 12(c)), the preconcentrated plug is located between the two heaters (FIG. 12(a)) with enhanced preconcentration (i.e. enhanced intensity and smaller length). Once the heating power is turned off (t₄, t₇), the preconcentrated plug moves back to its equilibrium steady-state location (t₁). When applying periodic step-wise ET flows by activation of the two heaters (t₂ to t₈), the preconcentrated plug with smaller length is repetitively released and relocated between the two heaters. The results may demonstrate that the location and extent of the preconcentrated plug can be precisely and dynamically controlled by activating local ET stirring by turning on/off multiple heaters.

In greater detail, FIGS. 12 (a)-12(e) show dynamic control of the preconcentrated plug using multiple heater operation in an open microchannel-membrane system. FIG. 12(a) is a schematic illustration of ET induced control of the location and size of a preconcentrated plug by activation of two heaters. FIGS. 12(b, d) are time-lapse images and corresponding intensity profiles showing the preconcentrated plug using a single heater operation at different locations; FIGS. 12(c, e) are time-lapse images showing that the activation of two heaters resulting in a more preconcentrated plug (i.e. increased intensity and localized preconcentration) in addition to control over its location. The red arrows and yellow rectangles indicate the activated heater and location of heater, respectively. A constant velocity u₁ of 450 nL/min (Pe=430) is used and t₁, t₂, t₃, t₄, t₅, t₆, t₇, t₈ are 670, 730, 965, 1165, 1500, 1840, 2500, 2840 s, respectively.

### Methods

### Design of a ET-CP Platform

The designed ET-CP platform (FIG. 10(a)), is similar to previously studied open microchannel-Nafion interface devices that consist of a polydimethysiloxane (PDMS) main channel (300 μm in width, 14 mm in length, 400 μm in depth) as an anode channel and Nafion membrane (300 μm in width, 1 mm in length) interconnected to the main channel and side chambers (2 mm in diameter). The platform of the present embodiments includes an array of individually addressable heaters (20 μm in width, 240 μm in length, ˜15052) which are embedded to supply an external heating source to generate a temperature gradient. In order to actively drive electro-convection by the electrothermal forces only, the electrodes are electrically insulated from the electrolyte via a thick dielectric coating using silicon nitride (1.8 μm in thickness). A feature of a platform according to the present embodiments is that ET can control the preconcentration plug spatio-temporally, for example by turning on and off, say stepwise or at a given frequency. The distance between the Nafion interface and closed edges of the 1^{st} heater and 2^{nd} heater are 650 and 2650 μm, respectively.

### Experimental Setup

For CP generation, four external platinum electrodes (0.5 mm-diameter) are inserted at each end of a main channel and two side reservoirs and connected to a voltage source. A symmetric voltage application between the main microchannel inlets and the side channels with an interconnecting Nafion membrane is used. Details of the chip wetting and cleaning steps prior to experiments are as discussed hereinabove. For ionic concentration profiles, 5 μM concentrations of pH-free Dylight fluorescent molecules (Dylight 488, Thermo Scientific) are mixed in a 1 mM KCl solution with conductivity of 180 μS/cm. The convective net flow is driven by syringe pump (withdrawal mode) with various flow rates from 100 to 500 nL/min, having Pectlet (Pe) numbers of 97 to 486. For ET induced flow, the microheater, connected to a DC power supply (Agilent 3612A), is separately activated with a heating power of 180 mW. All experiments are recorded with a spinning disc confocal system (Yokogawa CSU-X1) connected to a camera (Andor iXon3). The measured fluorescent intensities are further analyzed by normalizing the local fluorescent dye intensity by that of initial intensity before applying electric field.

Considering FIGS. 13(a) to 13(d) in greater detail, the dependency of the location of the preconcentrated plug on the applied flow rate (FIG. 13(a) and FIG. 13(b)) and voltage (FIG. 13(c) and FIG. 13(d)) is shown. As seen in FIG. 13(a), and FIG. 13(b) the preconcentrated plug forms closer to the membrane interface with increasing flow rate or decreasing voltage. Here, the embedded electrodes were not operated.

### Embodiment 3

Embodiment 3 demonstrates how to bring a probe to the location of the biomolecule to ensure that binding between the target biomolecule and the molecular probes occurs, by combining dielectrophoresis and concentration polarization based simultaneous preconcentration of biomolecules and functionalized micro/nanoparticles for a sensitive immunoassay. Instead of dielectrophoresis, other forces acting on the particles can be used (e.g. magnetophoresis, optophoresis, electrophoresis, thermophoresis, diffusiophoresis etc.).

More particularly the embodiment demonstrates binding of the target biomolecules to probes which are fixed on surfaces. The probes may either be on some surface within the microchannel or on the surface of a colloid. The latter has the advantage of being able to be located dynamically.

Concentration-polarization (CP) based biomolecule preconcentration proves to be useful for enhancement of the detection sensitivity of biomolecules in an immunoassay. Nanoparticle based antibody immobilization has several advantages over immobilization on the microfluidic surface (e.g. ease of immobilization, change of desired antibodies). In the fourth embodiment, we use freely suspended nanoparticles that are also preconcentrated at the same location of the biomolecule for enhanced binding kinetics. For post-processing of the signal nanoparticles are trapped using an array of interdigitated electrodes, then washed and released for further analysis. Hence, the microfluidic device consisted of a Nafion membrane to induce the CP and an array of individually addressable electrode pairs for DEP trapping. A clear increased sensitivity may be obtained for such a platform using avidin-biotin particle conjugation as a model for bead-based immunoassay.

### Introduction

The unique property of ion exchange membranes is their ion permselectivity stemming from the charged surface groups which allow predominantly counterions to pass through unimpeded while co-ions are excluded due to electrostatic exclusion. Under non-equilibrium conditions, i.e. application of an external field, such a symmetry breaking phenomenon results in the formation of ionic depleted and enriched layers at the opposite membrane-electrolyte interfaces, a phenomenon known as concentration-polarization (CP). The ability to induce regions of high and low ionic concentrations adjacent to a permselective membrane or a nanochannel subject to CP has been the focus of intensive research in the last decade, particularly regarding its relation to microfluidic applications, e.g. on-chip desalination where the CP layer is used to separate between brine and desalted streams, or enhanced immunoassay sensing by preconcentration of analytes at the edge of the depletion layer, as discussed hereinabove. Among various applications, a CP-based preconcentration, occurring at the outer edge of the depletion layer due to counteracting convective versus electromigrative ion fluxes, is very promising for highly sensitive immunosensing as it has million-fold preconcentration. In the recent years various microfluidic preconcentration systems have been investigated using various ion permselective medium such as nanochannel, porous membrane and polyelectrolytic gel for enhanced detection.

Combining CP-based preconcentration of target biomolecules and surface immobilized molecular probes may enable a highly sensitive immunoassay. For example, Ko et al. reports such an immunoassay where C-reactive proteins are preconcentrated using CP above surface patterned immobilized antibodies. Wang and Han also demonstrate an enhancement of bead-based immunoassay in which nanoparticles functionalized with antibodies are hydrodynamically trapped in narrow gaps while the CP-based preconcentrated plug of target biomolecules overlaps them. However, as discussed above with the third embodiment, the main deficiency in CP-based preconcentration system is the inability to precisely and dynamically control the location of the preconcentrated biomolecule plug. Such an ability would be extremely useful in overlapping between the preconcentrated plug of target molecules and the surface immobilized antibodies so as to enhance the detection sensitivity and binding kinetics. In cases where the antibodies are fixed to the surface of the microchannel some pre-calibrations are necessary in order to ensure that such an overlap occurs, since the chances of it doing so are very sensitive to the system parameters (e.g. flow rate, voltage, channel geometry etc.). However, according to the present embodiments, a different strategy that completely avoids the need to tune the relative locations of the preconcentrated plug and the surface probes is simply to use functionalized beads that are simultaneously preconcentrated with the target molecules at the same location just outside the depletion layer and after the incubation time trapped using dielectrophoresis (DEP) for postprocessing of the signal.

A bead-based assay has several important advantages over surface immobilized antibodies, such as avoiding the need to pattern the antibodies within the microchannel, the relative ease of coating the nanoparticles with antibodies, the ability to dynamically control the location of the trapped beads and even to release them for further analysis. Unlike hydrodynamic trapping of the beads using geometrical barriers or integration of a microvalve array, solutions that both suffer from either a prefixed location or increased complexity, here, we suggest to use DEP as means of manipulating the beads. Dielectrophoresis (DEP), defined as the translational motion of neutral particles due to effects of polarization in a non-uniform electric field, is a well-established technique that is used for probing and/or manipulating bio-particles by their unique dielectric properties under alternating current (AC) fields. In particular, a crossover frequency (COF), which is an AC frequency at which the DEP vanish, i.e. particles shift from attraction (positive DEP) to repulsion (negative DEP), can be used as a sensitive discriminator between different particle types or condition and can be utilized for particle trap and separation.

Thus according to the present embodiment a unique DEP-CP platform as per FIGS. 10a-b above, is made, which consists of an open microchannel-membrane system that supports net flow (either pressure driven or through electro-osmotic flow (EOF)) between two opposite microchannel inlets with a perm-selective Nafion membrane embedded in between for CP-based preconcentration. An array of individually addressable electrodes is embedded at the upstream microchannel, for the DEP trapping of functionalized nanoparticles. In a demonstration of immunoassay, biotin-avidin conjugation is used to show the efficiency of the system. Such a platform may dynamically trap/release the functionalized nanoparticles along with a preconcentrated biomolecule plug for enhanced detection sensitivity and binding kinetics.

Materials and Methods

Design of a DEP-CP Platform

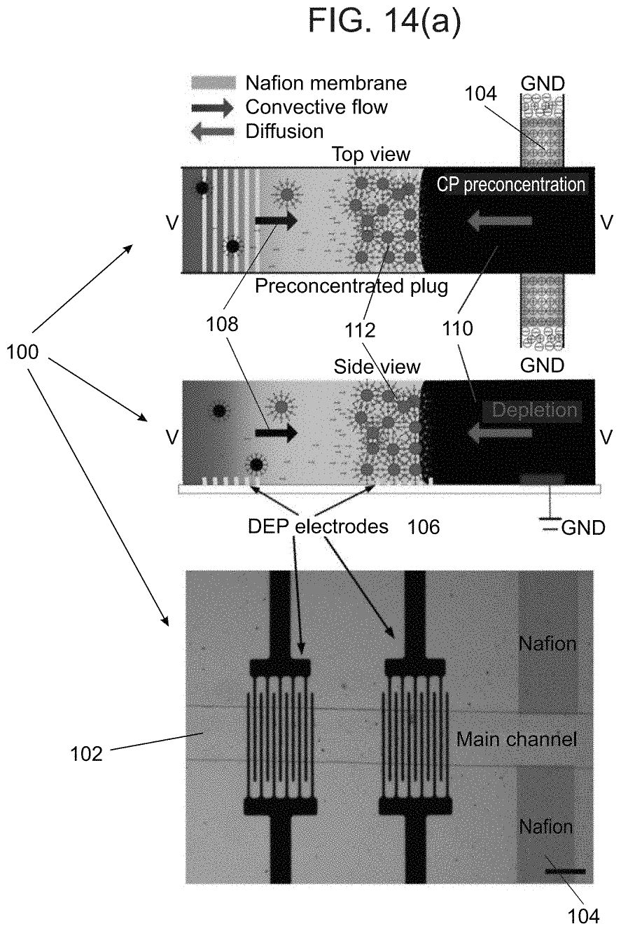

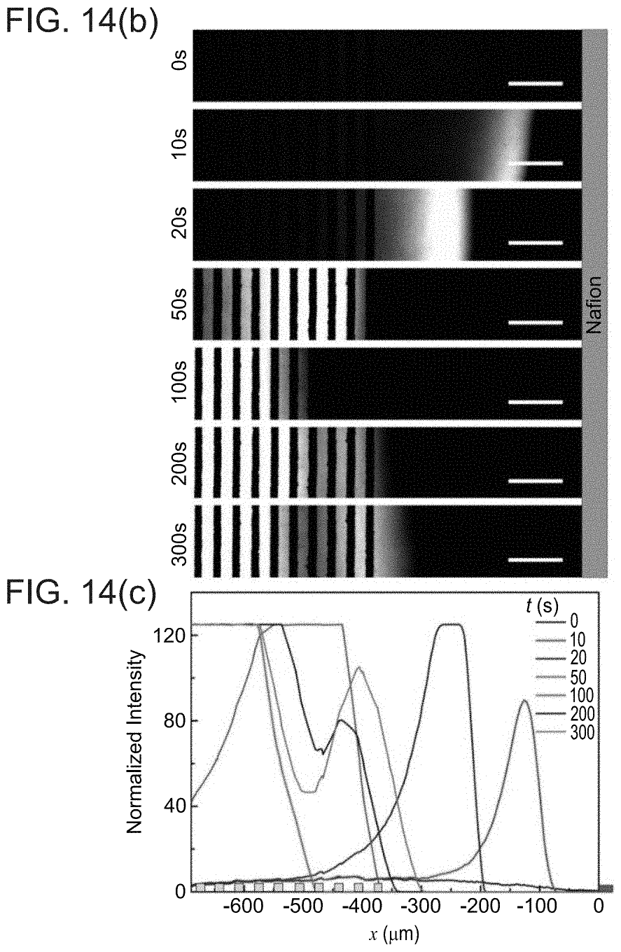

Reference is now made to FIG. 14(a) which shows a DEP-CP platform 100 according to the fourth embodiment. The platform consists of a polydimethysiloxane (PDMS) main microchannel 102 (300 μm in width, 16 mm in length, 25 μm in depth) with an embedded Nafion membrane 104 (300 μm in width, 1 mm in length) that interconnects the main microchannel and side chambers (2 mm in diameter). The two microchannel inlets are symmetrically powered while the side chambers are grounded such that the microchannel behaves as the anodic side wherein the depletion layer forms. In a DEP-CP platform, the design is similar to previously studied open microchannel-Nafion interface devices. However the present embodiments include an interdigitated DEP electrode array 106 (25 μm in width, 25 μm space between two electrode lines) which is embedded upstream of the Nafion membrane interface, where the term upstream is defined based on the direction of convective flow-arrow 108. The distance between the eNafion interface and the edges of the 1^{st} and 2^{nd} electrodes array are 375, 1125 μm, respectively. The time-averaged DEP force for a homogeneous dielectric spherical particle suspended within an electrolyte under a non-uniform electric field, is represented by F_{DEP}=πεₑR³Re(K*)∇|E|², where R is the radius of the particle, E is the amplitude of electric field, εₑ is the permittivity of the electrolyte and Re (K*) is the real part of the Clausius-Mossotti (CM) factor. The CM factor is defined as

$${K}^{*} ( ω ) = ( {ɛ}_{p}^{*} - {ɛ}_{e}^{*} ) \text{/} ( {ɛ}_{p}^{*} + 2 {ɛ}_{e}^{*} ) , \\ {ɛ}^{*} = ɛ + \frac{σ}{j ω} ,$$

where ε*ₚ and ε*ₑ are the complex permittivities of the particle and the electrolyte, respectively, and ε and σ represent the real permittivity and the conductivity respectively. It depends on the frequency which determines both the direction of the DEP force and its magnitude. As frequency increase, CM factor of the polystyrene particle in electrolyte goes from positive to negative corresponding to a transition of particles from attraction (positive DEP) to repulsion (negative DEP).

Experimental Setup

For CP generation, four external platinum electrodes (0.5 mm-diameter) are inserted at either end of the main channel 102 and two side reservoirs and connected to a voltage source. A symmetric voltage is applied on the two ends of the main channel 102 to minimize the effect of electroosmotic flow. Details of the chip wetting and cleaning steps prior to experiments are as discussed above. For ionic concentration profiles, 5 μM concentrations of pH-free Dylight molecules (Dylight 488, Thermo Scientific) are mixed in the 10× diluted PBS in distilled water, and the measured solution conductivity is 180 μS/cm. The net flow is driven by a hydraulic pressure difference between microchannel inlets. The measured intensity of the fluorescent dye is further analyzed by normalizing the local fluorescent dye intensity by that of an initial intensity before electric field application. For DEP, we apply an AC field frequency (80-100 kHz, 10Vₚₚ) with a sinusoidal waveform on the interdigitated DEP electrodes array using a function generator (33250A, Agilent). All experiments are recorded with a spinning disc confocal system (Yokogawa CSU-X1) connected to a camera (Andor iXon3) as in the previous embodiments.

Preparation of Avidin and Biotin Particles

As a demonstration for the bead-based immunoassay, commercially available biotin-linked polystylene particles with 0.8 μm in diameters (Spherotech) are used. As target molecules, fluorescein-tagged avidin D (Vector laboratories) with varying of their concentrations are used. The detection of the conjugation between biotin and avidin is obtained by the fluorescent intensity. The incubation time for the conjugation is 20 minutes at room temperature in all experiments. Prior to performing the conjugation process, non-specific binding effect between the biotin-tagged particles and the fluorescent molecules without avidin (e.g. Dylight molecules) were conducted so that no fluorescent intensity was observed at the particles after incubation time. Also, we were able to confirm that no significant background intensity was observed at the avidin solution with the maximum concentration (10 μg/mL) in our experiments. In any event we have subtracted the background intensity from the intensity measurements.

Schemes for Conjugating Avidin-Biotin Particles

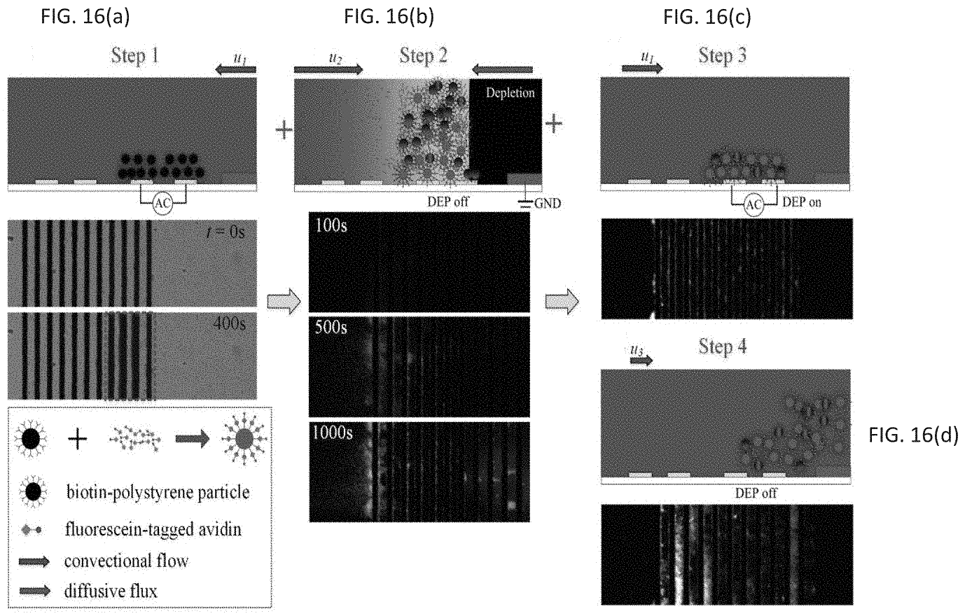

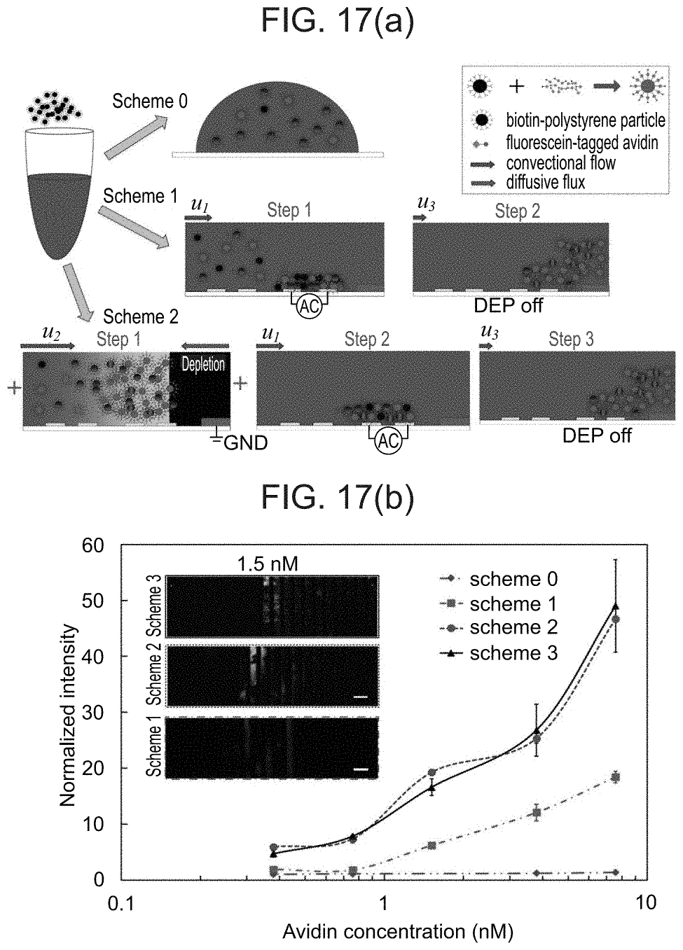

Various immunoassay schemes may be conducted for demonstrating the enhanced sensitivity effect as shown in the schematics of FIGS. 16(a)-(d) and FIGS. 17(a)-(b). Scheme 0 is a control, a bulk test, measuring the intensity from the droplet of biotin-avidin mixture. Scheme 1 is concentration of the biotin-particles by DEP trapping within the microchannel. Scheme 2 is single sample loading with generation of a preconcentrated plug by CP which has 3 steps: loading and pre-concentration of the mixed avidin and biotin-linked nanoparticles (˜10 μg) by CP, trapping the concentrated and conjugated particles by DEP during wash, and releasing the particles for the analysis. Scheme 3 comprises multi-sample solution loading with CP which represents a commonly used sandwich immunoassay (FIGS. 14(a)-(c)). The difference between scheme 1 on the one hand and schemes 3 and scheme 2 on the other is that biotin-particles (˜0.14 μg) were introduced first and trapped first (step 1), then the floating particles in the channel and reservoir were washed out using 0.01×PBS. Next, various concentrations of avidin molecules were introduced and preconcentrated by CP where the trapped biotin particles were located (step 2). At step 3 and step 4 we wash with DEP and release, as described in step 2 and 3 at scheme 2. In order to detect the conjugation of biotin and avidin quantitatively, we take the two or three interrogation windows during the release step where the maximal particle intensities exist. Then we further analyze using the normalized integral intensity and peak intensity. All data points take at least three repetitions. Using transparent electrodes (e.g. patterned ITO coated glass) may enable detection of conjugation, using our inverted microscope setup, without the need to release in order to visualize activity in between the Au opaque electrodes.

### 1. Results and Discussion

Generation of Preconcentration Biomolecule Plug in a DEP-CP Platform

Without applying net convection though the microchannel the application of the same voltage at the extreme ends of the channel may result in a symmetric propagation of the depletion layer without the formation of pre-concentration plugs. However, existence of advection in the system causes a formation of a preconcentrated plug at the edge of the depletion layer in the upstreaming channel relative to the Nafion interface due to field-gradient-focusing effect by counteracting advection and electromigration (see FIG. 14(a)). For a certain microchannel geometry and ionic strength, the length of the depletion layer, which in turn dictates the location of the preconcentrated plug at its edge, strongly depends on the applied flow rate and the electric field (see FIGS. 13(a)-(d)).

In more detail, FIGS. 14(a)-(c) show generation of a CP induced molecule and freely suspended functionalized nanoparticles preconcentrated plug within a DEP-CP platform. FIG. 14(a) is a schematic illustration of the preconcentration of biomolecules and functionalized beads (micro/nanoparticles) at the edge of the depletion layer and a microscopic image of a fabricated DEP-CP platform. The black bar 110 indicates depletion and is 200 μm. The preconcentration plug 112 is located at the end of the depletion region 110. FIG. 14(b) shows time-lapse fluorescent images upstream of the microchannel-membrane interface showing the formation of preconcentration of fluorescent molecules under constant flow (200 μm/s). FIG. 14(c) shows a corresponding graph that has been normalized by the initial value at t=0 s for fluorescent intensity distribution. Here, the DEP electrode array was not powered, and hence only acts as floating electrodes.

In the DEP-CP system where the 1^{st} DEP electrode array which is located 375 μm far away from the Nafion interface, a net flow of 215±40 μm/s and a fixed voltage (15V) were chosen so as to overlap the preconcentrated plug with the DEP electrode array. The resulting time-lapse images and their normalized intensities (FIG. 14b, c) indicate that the preconcentrated plug has settled above the 1^{st} electrode array. The achieved concentration was at least a 100 fold after 20 sec of CP-activation, which is lower than Ko et al. due to saturation of the fluorescent signal. In order to hold the preconcentrated plug at a desired location for long-term operation of more than 700 second, additional precise fluidic/voltage tuning may be required in the floating electrode system.

DEP Characterization of Nanoparticles Used for Bead-Based Immunoassay

In the system of the present embodiments, two physical mechanisms are integrated for the application of bead-based immunoassay; 1) CP for formation of preconcentrated plug, 2) DEP dynamic trapping and releasing of the antibody-conjugated nanoparticles.

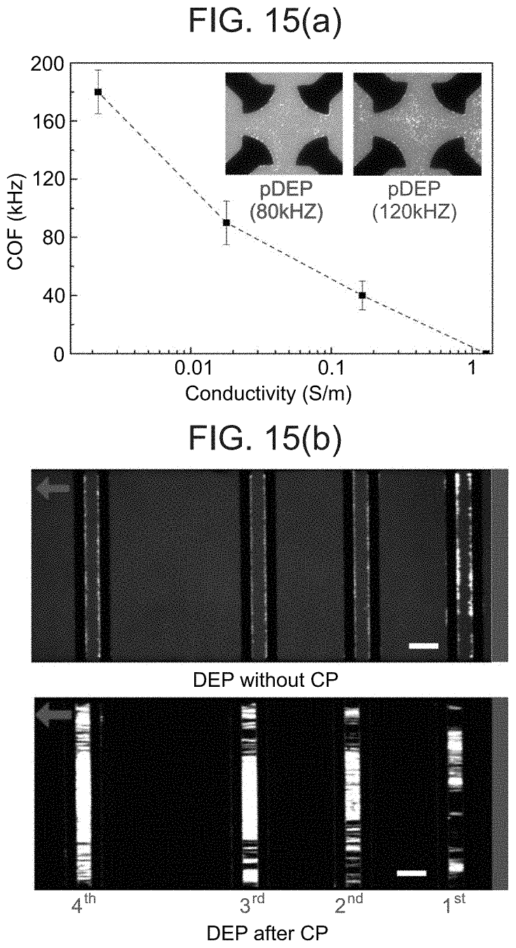

The DEP response of the biotin-coated polystyrene beads may first be characterized using a quadrupolar electrode array.²⁰ The crossover frequency (COF) of the biotin-coated particles, at which CM factor goes to zero and the DEP force vanishes, for various conductivities of PBS solution is depicted in FIG. 15(a). In order to prove the enhanced preconcentration of particles by CP, we compare intensities of the trapped particles with/without CP activation in the DEP-CP platform using red fluorescent particles (520 nm in diameter) with 5 μM concentrations of Dyight molecules in KCl (0.01 S/m) under same time duration (300 s). During the activations of CP, both fluorescent nanoparticles and molecules within the preconcentrated plug overlapped the area of the 3^{rd} and 4^{th} DEP electrodes. The results clearly show enhanced nanoparticle preconcentration when p-DEP is combined with CP-based preconcentration, resulting in a much more concentrated trapping of the particles above the overlapped electrodes compared to those at the 1^{st} electrode.

At a 0.01× diluted PBS (σₑ=0.018 S/m) the COF is ˜100 kHz and the biotin-particle and avidin still conjugates properly, hence, is chosen as the working electrolyte conductivity. In the DEP-CP platform, the avidin-conjugated and non-conjugated biotin particles are successfully trapped by pDEP (80 kHz, 10Vpp) under convective flow smaller than 40 μm/s with direction from right to left or vice versa, respectively (FIGS. 16(a), 16(c)). At flow rates above 70 μm/s, the particles are hydrodynamically sheared and thus pass over the electrode array upon activation of pDEP (80 kHz).

FIGS. 15a and 15b show EP characterization for biotin-linked particles and a demonstration of CP-preconcentrated effect on particle trapping by DEP. FIG. 15(a) shows the COF of the biotin-coated particles within various solution conductivities. FIG. 15(b) shows fluorescent images comparing DEP trapping with/without CP-based preconcentration using fluorescent particles (520 nm in diameter) in KCl solution with Dylight molecules. The applied AC field for DEP is 10Vₚₚ and 100 kHz. A red rectangle indicates the location of the Nafion membrane.

Conjugation of Avidin-Biotin Particles in a DEP-CP Platform

FIGS. 16 (a)-(d) describe a sensing scheme with multiple solution loading (Scheme 3), while other schemes are depicted in FIG. 17(a). In step 1, the biotin particles are introduced with flow (right to left direction) of 40 μm/s and most of them are trapped at the first two lines of the activated electrode array (FIG. 16(a)) while very few particles are observed to pass the electrode array. In step 2, the various concentrations of avidin molecules are introduced with convective flow (left to right direction, 200 μm/s) along with an external DC voltage (15V) for generation of the CP-based preconcentration plug of both avidin molecules and freely suspended nanoparticles (FIG. 16(b)). The AC electric field for DEP was turn off during the CP to reduce an unexpected non-linear electrokinetic effect by the AC field and also to release the nanoparticles that are able to preconcentrate at the edge of the depletion layer. It is clearly seen that the avidin-biotin conjugations are notably increased with enhanced fluorescent intensities after 500 s. In step 3, the conjugated particles are again trapped by DEP when afterwards the avidin solution is replaced with 0.01×PBS as a wash for 10 min (FIG. 16(c)). The avidin-biotin particles are successfully trapped at the edges of electrodes at frequency of 100 kHz. Most of the particles are immediately trapped after application of the AC field on the electrode, however some particles that were located above electrodes are affected by convectional flow. Finally, the conjugation of the avidin-biotin coated particles is analyzed by releasing the trapped particles (FIG. 16(d)), by turning off the DEP force, and using the lowest flow below 5 μm/s for better observation.

FIGS. 16(a) to 16(d) show an immunosensing scheme (scheme 3) including multiple sample loading/wash steps in a DEP-CP platform. The initial concentration of the loaded avidin is 3.8 nM in 0.01×PBS. FIG. 16(a) shows a first step of: trapping of the biotin particles using DEP (80 kHz, 10Vpp) under small background flow for washing. Time-lapse bright-field images indicate the trapped biotin-particles by DEP before and after 400 s. FIG. 16(b) shows a second step, step 2 of: conjugation of the simultaneously CP-preconcentrated avidins onto the preconcentrated freely suspended (after released from the DEP trap) biotin coated particles. Time-lapse fluorescent images indicate the transient conjugation of biotin and avidin in the preconcentrated plug. FIG. 16(c) shows step 3: trapping the conjugated particles using DEP during wash. FIG. 16(d) shows step 4: release the conjugated particles for analysis.

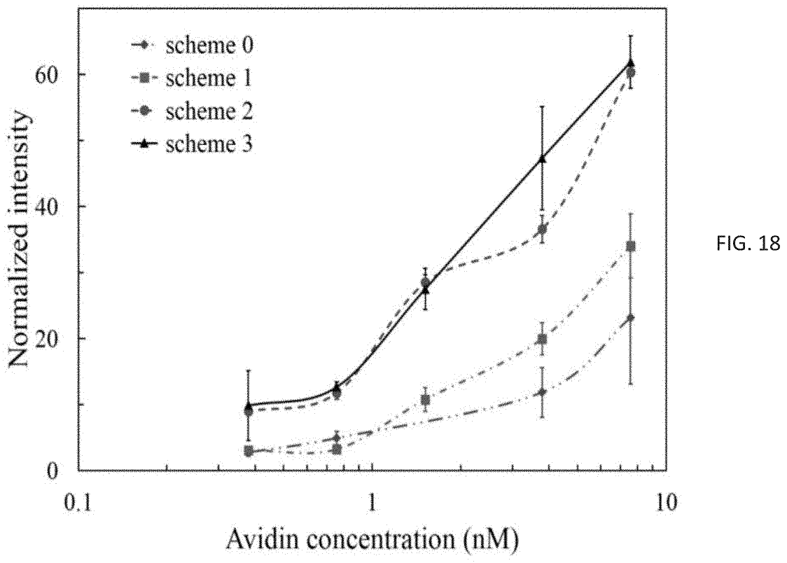

To validate the enhanced biosensing performance of the DEP-CP platform, avidin in a 0.01×PBS with various concentrations (7.6, 3.8, 1.5, 0.76, 0.38 nM) is used under various sensing schemes—FIG. 17(a). FIG. 17b shows the resulting normalized intensity as a function of avidin bulk concentrations of various schemes as measured during the release step. As expected, the intensity of the particles increases as the initial avidin concentration increases across the schemes. However, at scheme 0 which acts as a control, the normalized averaged intensity within the interrogation window is almost zero. The increase according to the concentrations at scheme 0 can be observed by measurement of the peak intensity (FIG. 18). In scheme 1, at which the mixed avidin and biotin particles are continuously trapped by DEP under convective flow, the obtained intensities are higher than those from scheme 0 due to concentrated biotin particles by DEP. Schemes 2 and 3 have a preconcentration step of the mixed avidin and biotin-coated particles that can be DEP trapped on demand using the electrodes. The results of scheme 2 and 3 clearly demonstrate an enhanced biosensing having three times higher intensity than those from scheme 1. These results demonstrate that both schemes with preconcentration by CP in our system enhance the sensitivity for immunoassay.

FIGS. 17(a) and 17(b) are now considered in greater detail. Various immunosensing schemes in a DEP-CP platform are shown as follows: Scheme 0: bulk droplet; scheme 1: preconcentration of beads using DEP; and scheme 2: single sample loading with CP generation. The schemes have one two or three steps, loading the mixed samples with CP-based preconcentration of both avidin and freely suspended beads, washing with DEP trapping of the beads, and releasing. FIG. 17(b) indicates the limit of detection of conjugation of biotin-avidin with various schemes indicating the enhanced detection sensitivity of schemes 2 and 3 using CP-based preconcentration.

FIG. 18 shows a peak measured fluorescent intensity as a function of avidin bulk concentrations using the various immunoassay schemes within the DEP-CP platform. As evident from the low avidin concentration the limit of detection (LOD) is significantly improved.

Conclusions

Here, a different strategy for an immunoassay test, using combined surface immobilized molecular probes and CP-based preconcentration of the target molecules, is used. In contrast with the prior art, where spatially fixed antibodies may or may not overlap the preconcentrated plug whose location is not dynamically controllable, but where overlap is critical for enhanced sensing, in the present embodiments we may simultaneously preconcentrate both at the edge of the depletion layer for enhanced detection sensitivity and binding kinetics. For post-processing of the signal, nanoparticles are trapped using an array of interdigitated electrodes. Hence, the studied platform has two clear advantages over similar CP-based approaches. Firstly—avoiding the need to overlap the target molecules and the surface immobilized molecular probes. Instead the present embodiments may tune their relative locations via the use of a bead-based assay that can simultaneously preconcentrate at the edge of the depletion layer together with the target molecules. Secondly, the dynamic trapping/release of the beads via DEP enables an accurate post-processing of the conjugations.

General

### Numerical Simulations

In connection with the present embodiments, we solve the combined ET, natural convection and electro-osmosis effects on the depletion layer dynamics via the fully coupled two-dimensional (2D) time-dependent model using the finite-element based software COMSOL (V5.3). The simplifying assumptions used are symmetric and binary electrolyte (z₊=−z₋=1) with equal ionic diffusivities (D₊=D₋≡D=2·10⁻⁹ m²s⁻¹) and an ideal-permselective membrane. The governing equations in the system are the continuity of ions, c_{±}, using the Nernst-Planck relation for the ion fluxes, jₜ, including the convective term

$$\frac{\partial {c}_{\pm }}{\partial t} = - ∇ \cdot {j}_{\pm } , \\ {j}_{\pm } = - D ∇ {c}_{\pm } ∓ \frac{F}{R T} D {c}_{\pm } ∇ φ + {uc}_{\pm } , \qquad ( 1 a )$$

the Poisson equation for the electric potential, ϕ, in terms of the excess ionic charge density, ρₑ

$${∇}^{2} φ = - {ρ}_{e} \text{/} ɛ ; \\ {ρ}_{e} = F {\sum }_{i} {z}_{i} {c}_{i} , \qquad ( 1 b )$$

the incompressible Navier-Stokes equations with both electrothermal and natural convection forcing using the Boussinesq approximation

$${ρ}_{0} \frac{\partial u}{\partial t} = - ∇ p + η {∇}^{2} u + {f}_{E T} + {ρ}_{0} {β}_{T} g ΔT , \\ ∇ \cdot u = 0 , \qquad ( 1 c )$$

and the energy equation for calculation of the temperature field, T

ρcₚ(∂T/∂t+(u·∇T))=k_{f}∇²T+\dot{q}. (1d)

Herein D, F, R, T, η=0.001 kg/m³, p, ρₛ, β_{T}, g, ε=80ε₀ (where ε₀ is vacuum permittivity) and ρ₀ represent the diffusion coefficient, Faraday constant, universal gas constant, temperature, fluid dynamic viscosity, pressure, free charge density, thermal expansion coefficient, gravitational acceleration, permittivity and mass density of the fluid at room temperature, respectively. Also, cₚ, k_{f} and \dot{q} in eq.(1d) represent the specific heat and thermal conductivity of the fluid and joule heating, respectively. In a system according to the present embodiments, the contribution of the joule heating, which is induced by the applied external field at the reservoir for CP is smaller (heat powers <12 μW) than the contributions from the heater, also the ratio of heat transfer by convection over advection, demonstrated by the thermal Peclet number, Pe_{T}=ρcₚu, H²/k_{f}L<0.087, u<100 μms⁻¹ is much smaller than one. Also steady-state conditions may be assumed while solving the temperature field. Accordingly, we have neglected the joule heating from the external electric field, thermal convective terms and viscous dissipation term in eq.(1d), yielding a simplified heat equation

k_{f}∇²T+\dot{q}=0. (1e)

The ET force, f_{ET}, results from the combined application of an external electric DC-field and temperature gradients generated by the heater

f_{ET}=A½ε[½(α−β)(∇T·E)E−½α∇T|E|²], (2)

where α=(1/ε)(∂ε/∂T)≈−0.4%/° C. and β=(1/σ)(∂σ/∂T)≈2%/° C. and A=3 is a prefactor used for fitting the experimental results.

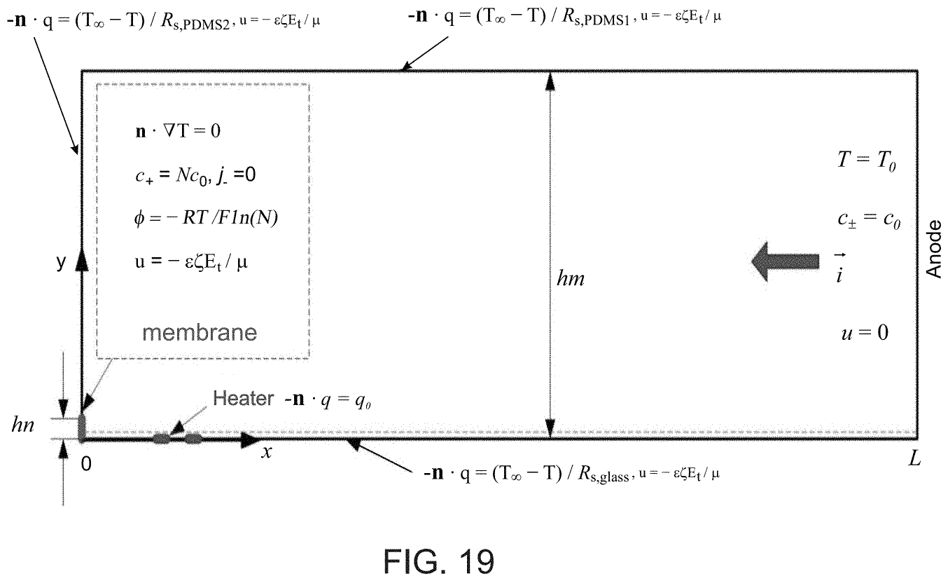

Reference is now made to FIG. 19, which is a simplified diagram that illustrates schematics of the 2D model, including the geometry and boundary conditions used in the numerical simulation for the microchannel domain at the anodic side of the membrane.

The numerical 2D model consists of a microchannel (length L=5 mm, height hₘ=0.75 mm) with embedded heaters interfacing the anodic side of an ideal cation-permselective membrane (height hₙ=200 nm) whose characteristics are shown in the graphs of FIG. 25. The boundary conditions at the membrane interface (x=0, y∈[0,hₙ]) are no penetration of anions (j₋=0), fixed cation concentration (c₊=Nc₀), and Donnan potential (−RT/F·ln(N)), with values c₀=1·10⁻³ molm⁻³ and N=10. At the reservoir boundary (x=L, y∈[0,hₘ]) a constant bulk concentration (c₊≈c₋≡c₀) is imposed along with uniform current density in terms of the electric displacement (D_{elec}=−ε(RT/F)(½FDc₀)i). An overlimiting current density (i=1.45i_{lim,1D}, i_{lim,1D}=2DFc₀/L) is applied. At the other channel walls no-penetration conditions and electrical insulation are used. For the electro-convective problem the Helmholtz-Smoluchowski (HS) slip velocity, u=−εζEₜ/η, was used at the channel walls wherein ζ=−10 mV and Eₜ are zeta potential and the tangential electric field component and open boundary condition at the reservoir.

The heater may have a serpentine geometry with an electrode width of 25 μm with its outer edges located at 500 μm and 725 μm spacing from the membrane. For the thermal problem, a uniform heat flux (q₀=Pᵣ/Aₕₑₐₜₑᵣ where Pᵣ and Aₕₑₐₜₑᵣ are the resistive heating power and area of heater) was used at the heater surface and constant room temperature (T₀=293.5 K) at the reservoir. Instead of solving also for the PDMS and glass domains these were accounted for by including their thermal resistances as boundary conditions

(T−T_{∞})/Rₛ=−k_{f}∇T, (3)

where for the PDMS upper layer the thermal resistance, R_{s,PDMS1}=t_{PDMS}/k_{PDMS}+1/h, consists of both conduction and convection contributions in series³¹ with thickness t_{PDMS1}=3 mm, thermal conductivity k_{PDMS}=0.27 Wm⁻¹K⁻¹, and natural convection heat-transfer coefficient of h≈10 Wm⁻²K⁻¹. At the lower surface interfacing a glass of thickness t_{glass}=1 mm and thermal conductivity k_{glass}=1.3 Wm⁻¹K⁻¹, and at the PDMS side wall with thickness t_{PDMS2}=1 mm, only the thermal resistances due to conduction are accounted for, i.e. R_{s,glass}=t_{glass}/k_{glass} and R_{s,PDMS2}=t_{PDMS2}/k_{PDMS}, respectively, since isothermal conditions are assumed at the glass and the PDMS outer surfaces due to its direct contact with the microscope stage and the isothermal solution in a cathode channel.

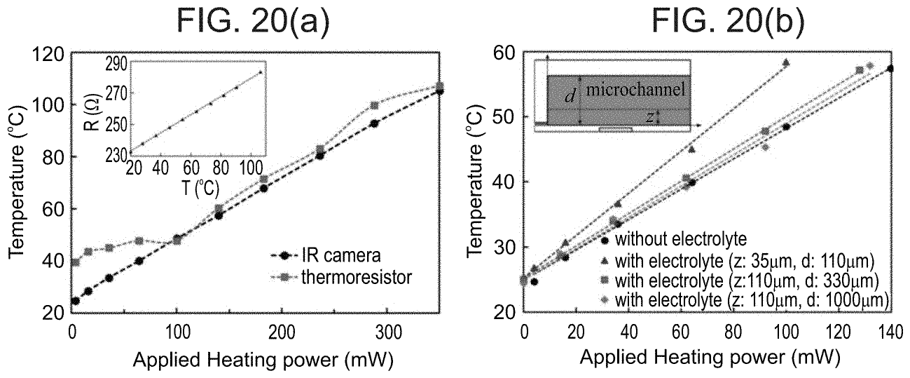

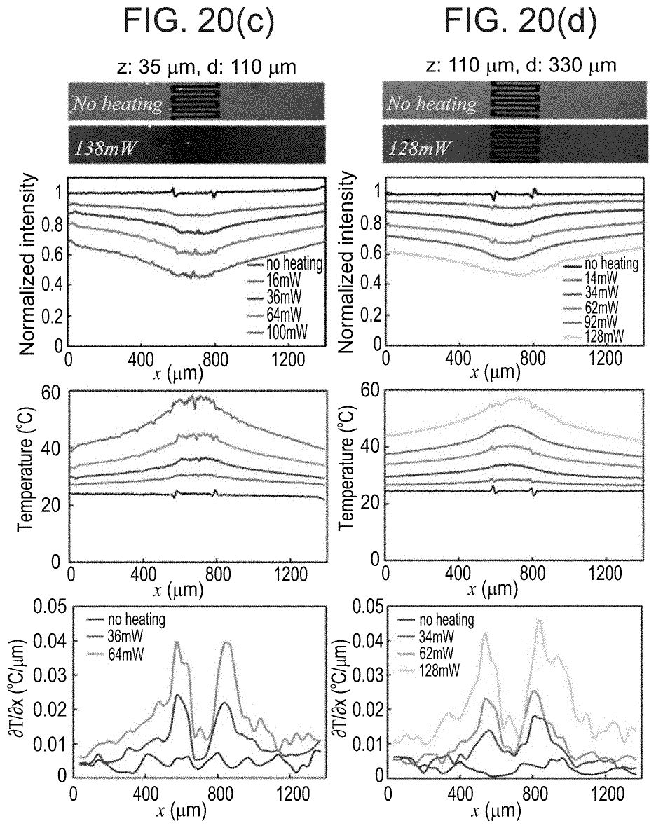

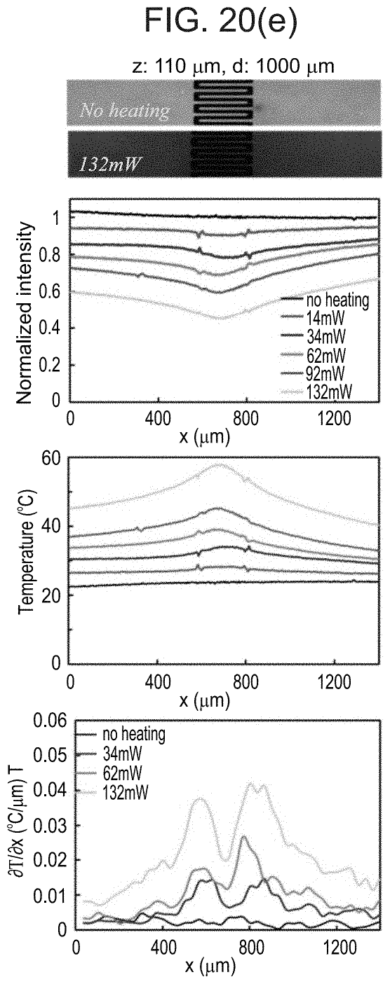

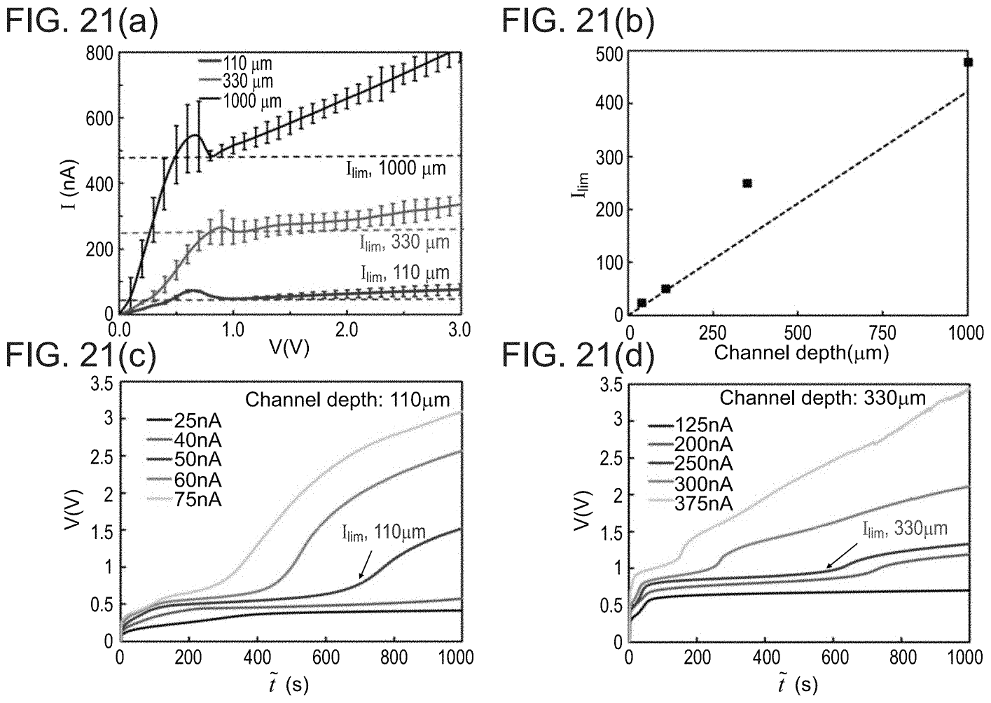

Reference is now made to FIGS. 20(a)-20(e). FIG. 20 (a) illustrates direct measurement, using an IR camera, of the heater temperature as a function of applied heating power without electrolyte and by extracting the temperatures from the resulting thermoresistor. The inset indicates linear relation between the resistance of the heater to temperature to calibrate temperature coefficient of resistance (α=0.0025); FIG. 20(b) shows indirect measurement of the maximum temperature in the membrane-microchannel systems with electrolyte using temperature sensitive dye. The inset indicates the schematic of measured depths of focal plane z, and the microchannel (d). FIGS. 20(c)-20(e) show microscopic images and normalized intensity of Rhodamine B fluorescent dye in the microchannels at \tilde{t}=400 s for varying heat powers, following their correlated temperature fields and temperature gradient fields.

Returning to FIGS. 9(a) and 9(b), and FIG. 9(a) shows a measured velocity component along the x-axis, u, within a microchannel 110 (d=400 μm, z₁=100 μm) without a membrane as a function of various applied AC field intensity at a frequency of 1 kHz and a fixed heating power of 60 mW. The inset indicates a focal plane (z₁=100 μm) and measuring regions (grey rectangles) for averaged velocity toward the heater, the heater being located between 100 and 250 μm from the edge of the microchannel. FIG. 9(b) shows the average measured velocity as function of E₀² (blue markers) and numerical approximations of ET velocities (u_{ET}=0.5×ε(α−β)E² (∇T)L²η⁻¹) for scaling argument. Herein, u_{NC} is the measured average velocity of the natural convection (21±4.7 μm s⁻¹). Quadratic scaling, E₀², yields the best fit, compared to E₀ or E₀⁴.

Reference is now made to FIGS. 21(a) to 21(f), which show characterization of the CP effect within the membrane-microchannel system without ET flow and for various microchannel depths: FIG. 21(a) shows current-voltage (I-V) response with a voltage sweep rate of 1 mV/s, where the limiting currents, Iₗᵢₘ, are indicated by dashed lines; FIG. 21(b) shows correlation of Iₗᵢₘ with channel depth. The dashed line shows a linear fit extracted from Iₗᵢₘ=2zFDc₀(2 dW)/L, where d, W and L are channel depth, width and length respectively; FIGS. 21(c, d, e) show chronopotentiometric (V-t) response with various currents (0.5, 0.8, 1, 1.2, and 1.5×Iₗᵢₘ) for various microchannel depths; and FIG. 21(f) shows sand time vs. the inverse of the current density squared.

FIG. 22 shows time evolution of the depletion layer growth (intensity normalized by its bulk value) at the anodic side of the microchannel-membrane interface of the systems relating to FIGS. 6(c), 6(f) and 6(i)) above.

FIG. 23(a)-23(f) illustrate the effect of ET induced flow on the CP behavior for various applied external currents (0.5, 1, 1, 5, 2, and 3×Iₗᵢₘ) in membrane-microchannel systems with 330 FIGS. 23(a), (c), and (e) and 1000 μm-depth FIGS. 23(b), (d), and (e). The dashed and solid lines in all graphs represent the case of no-heating and applied heating power of 60 mW, respectively. In FIGS. 23(a)-23(d) the normalized (by the bulk value) fluorescent intensities of the depletion layer growth is at \tilde{t}=500 s, and FIGS. 23(e) and 23(f) show the corresponding V-t response.

Reference is now made to FIG. 24, which is a series of graphs that illustrate time evolution of the depletion layer growth (intensity normalized by its bulk value) at the anodic side of the microchannel-membrane interface of the systems (channel depth 330 μm) as a function of various applied currents with/without heating.

Reference is now made to FIG. 25 which shows a series of graphs illustrating a time evolution of the depletion layer growth (intensity normalized by its bulk value) at the anodic side of the microchannel-membrane interface of the systems (channel depth 1000 μm) as a function of various applied currents with/without heating.

Reference is now made to FIGS. 26(a)-26(c) which show numerically computed temperature (a) and velocity fields with Helmholtz-Smoluchowski slip velocity (b) boundary conditions at t=(\tilde{t}/\tilde{t}_{d})=1.2, \tilde{t}_{d}=L²/D and various combinations of the various flow modes (EOF, NC, ET). The corresponding chronopotentiometric (V-t) responses are depicted in parts (c). The applied current density is I/Iₗᵢₘ≅1.45 and zeta potential is ζ32−10 mV. The color bar stands for the magnitude of the induced velocities. Black lines and arrows indicate the flow streamlines and velocity vectors, respectively, while the two red arrows 120 point the locations of the heater lines, the lines being of 25 μm in width.

Reference is now made to FIG. 27, which is a simplified graph illustrating a measured temporal change of the velocity component u within a membrane-microchannel system (d=330 μm, z₁=100 μm) under the application of the heater (60 mW) and constant applied current (375 nA). The blue 130 and red 134 indicate the velocities at the left and right sides of the heater with measuring ranges in between 50 and 200 μm far from the outer edges of the heater respectively. The insets are corresponding microscopic images at time of 100, 300, and 500 s respectively indicating the simultaneous occurrence and development of a concentration-polarization layer.

It is expected that during the life of a patent maturing from this application many relevant microchannel technologies, membrane technologies and platforms will be developed and the scopes of the corresponding terms are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the text is to be construed as if such a single embodiment is explicitly written out in detail. Conversely, various features of the invention, which are, for brevity, described in the context of a single embodiment, may also be provided separately or in any suitable subcombination or as suitable in any other described embodiment of the invention, and the text is to be construed as if such separate embodiments or subcombinations are explicitly set forth herein in detail.

Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A microchannel-membrane device comprising:
first and second electrodes for generating a concentration-polarization layer;
a microchannel extending through at least said first electrode, the microchannel having a predetermined depth;
an ionic permselective medium across said microchannel between said first and second electrodes; and
at least one heater embedded below said microchannel on a first side of said permselective medium.

2. The microchannel-membrane device of claim 1, wherein said at least one heater comprises an array of heaters embedded below said microchannel at intervals along said first side of said permselective membrane, or wherein said at least one heater comprises an array of thin film microheaters, or wherein heaters of said array are separately controllable to define heating locations along said microchannel.

3. The microchannel-membrane device of claim 1, wherein said predetermined depth is greater than 0.3 mm or 0.4 mm, or about 1 mm, or 1 mm, or 1.5 mm.

4. The microchannel-membrane device of claim 3, wherein said heaters are controllable to generate an ET-induced vortex, therewith to limit growth of a diffusion length to said first location on said first side, said first side being a depletion side of said membrane.

5. The microchannel-membrane device of claim 4, wherein said heaters are dynamically controllable to change between heating locations, thereby to move said ET-induced vortex along said microchannel and alter said desired length.

6. The microchannel-membrane device of claim 1 wherein said at least one heater or array comprises a dielectric coating, thereby to provide an insulation layer, or wherein the at least one heater or array is controllable to a predetermined frequency, or wherein the at least one heater or array is controllable to apply varying voltages.

7. The microchannel-membrane device of claim 1, comprising a preconcentrated plug of target biomolecules preformed at said depletion end of said diffusion length.

8. The microchannel-membrane device of claim 7, wherein said at least one heater or array is controllable to locate said preconcentrated target biomolecules with prefixed probes on a surface of said microchannel, or on the surface of a colloid within said channel.

9. The microchannel-membrane device of claim 8, configured to apply dielectrophoresis, and/or magnetophoresis and/or optophoresis and/or electrophoresis and/or thermophoresis and/or diffusiophoresis forces, with functionalized micro or nanoparticles in order to control their manipulation, thereby to perform an immunoassay.

10. The microchannel-membrane device of claim 9, wherein said probes are configured to operate via micro or nanoparticle-based antibody/and or molecular probe immobilization.

11. The microchannel-membrane device of claim 10, further comprising an array of interdigitated electrodes for trapping said micro or nanoparticles.

12. The microchannel-membrane device of claim 11, wherein said interdigitated electrodes are pairwise addressable to carry out said dielectrophoresis to trap said micro or nanoparticles, or wherein said interdigitated electrodes are further controllable by said pairwise addressing to release said micro or nanoparticles after entrapment for further analysis.

13. The microchannel-membrane device of claim 12, wherein said immunoassay is bead-based.

14. The microchannel-membrane device of claim 1, wherein said ion permselective medium comprises any one of the group consisting of an ion permselective membrane, a Nafion membrane, a fabricated nanochannel, fabricated nanopores, and electrodes that generate faradaic reactions, thereby to induce concentration polarization (CP) in said microchannel.

15. The microchannel-membrane device of claim 1, wherein the microchannel extends between the first and second electrodes, or wherein the second electrode is in a side microchannel.

16. A method for controlling a location of a concentration-polarization layer within a microchannel-permselective membrane system by:
placing an ionic permselective medium across a microchannel;
applying a voltage across said ionic permselective medium to induce a concentration-polarization layer consisting of both ionic depletion and enrichment diffusion layers over a diffusion region having a length along said microchannel across said membrane in said microchannel; and
inducing a vortex at a predetermined location in said microchannel to limit growth of said diffusion region at said depletion side, thereby to define a location of said concentration polarization layer.

17. The method of claim 16, wherein said inducing a vortex comprises using electrothermal (ET) forcing.

18. The method of claim 17, wherein said ET forcing comprises applying an electric field and inducing temperature gradients.

19. The method of claim 18, wherein the temperature gradients are formed using one member of the group consisting of a predesigned heater, a fabricated heater, a fixed heater, dynamically patterned heating using laser illumination, dynamically patterned heating using a combination of laser illumination and photoconductive coating, and heating induced by a chemical reaction, heating induced by magnetism, heating induced by optical radiation and heating induced by electrical fields.

20. The method of claim 19, comprising dynamically changing said predetermined location by changing or moving said temperature gradients.

21. The method of claim 20, wherein said changing or moving said temperature gradients comprises turning on and off heating elements located across said microchannel.

22. The method of claim 21, comprising carrying out said turning on and off in a periodic manner, or in a shaped or a stepwise manner or with varying heating powers, or using a frequency of said turning on and off as a control parameter.

23. The method of claim 16, comprising carrying out electrodialysis, or CP-based desalination, or obtaining a preconcentration of target biomolecules at the edge of a depletion layer part of said concentration/polarization region, or preconcentrating functionalized beads for colocation with the target biomolecules just outside said depletion layer, or carrying out ionic current rectification (ICR) upon reversal of the externally applied electric field.

24. The method of claim 16, wherein the ion permselective medium comprises a membrane, or a nanochannel, or a nanopore or an electrode, or a Nafion membrane.
